(19) United States
(12) Patent Application Publication
(10) Pub. No.: US 2026/0017162 A1
(43) Pub. Date: Jan. 15, 2026

(54) SIGNAL TRANSMISSION DEVICE, ELECTRONIC DEVICE, AND VEHICLE

(71) Applicant: ROHM CO., LTD., Kyoto-shi (JP)

(72) Inventors: Akio SASABE, Kyoto-shi (JP); Daiki YANAGISHIMA, Kyoto-shi (JP); Takeshi KIKUCHI, Kyoto-shi (JP)

(21) Appl. No.: 19/336,794

(22) Filed: Sep. 23, 2025

Related U.S. Application Data
(63) Continuation of application No. PCT/JP2024/009292, filed on Mar. 11, 2024.

(30) Foreign Application Priority Data
Mar. 30, 2023 (JP) 2023-054502

(51) Int. Cl. G06F 11/27; G06F 11/22; G06F 11/25

(52) U.S. Cl. CPC G06F 11/27; G06F 11/221; G06F 11/25

(57) ABSTRACT

A signal transmission device includes a first chip fed with an input pulse signal and a second chip that drives a switching device by generating an output pulse signal according to the input pulse signal through isolated communication with the first chip. The second chip includes a self-diagnosis circuit that checks whether individual parts of the second chip are operating properly in response to a self-diagnosis instruction transmitted from the first chip only when the output pulse signal is at a logic level corresponding to an off state.

### CROSS REFERENCE TO RELATED APPLICATIONS

This application is a continuation under 35 U.S.C. § 120 of PCT/JP2024/009292, filed Mar. 11, 2024, which is incorporated herein by reference, and which claimed priority to Japanese Application No. 2023-054502, filed Mar. 30, 2023. The present application likewise claims priority under 35 U.S.C. § 119 to Japanese Application No. 2023-054502, filed Mar. 30, 2023, the entire content of which is also incorporated herein by reference.

### TECHNICAL FIELD

The present disclosure relates to a signal transmission device, an electronic device, and a vehicle.

### BACKGROUND ART

Today, signal transmission devices that transmit a signal between a primary circuit system and a secondary circuit system while electrically isolating between them are employed in various applications (such as power supply devices and a motor driving devices).

One example of known technology related to the above is found in Patent Document 1 by the applicant of the present disclosure.

### CITATION LIST

### Patent Literature

Patent Document 1: JP 5926003 B2

### BRIEF DESCRIPTION OF DRAWINGS

FIG. 1 is a diagram illustrating the basic configuration of a signal transmission device.

FIG. 2 is a diagram illustrating the basic structure of a transformer chip.

FIG. 3 is a perspective view of a semiconductor device used as a two-channel transformer chip.

FIG. 4 is a plan view of the semiconductor device shown in FIG. 3.

FIG. 5 is a plan view of a layer in the semiconductor device shown in FIG. 3 where low-potential coils are formed.

FIG. 6 is a plan view of a layer in the semiconductor device shown in FIG. 3 where high-potential coils are formed.

FIG. 7 is a cross-sectional view taken along line VIII-VIII shown in FIG. 6.

FIG. 8 is an enlarged view (showing a separation structure) of region XIII shown in FIG. 7.

FIG. 9 is a diagram schematically showing an example of the layout of a transformer chip.

FIG. 10 is a diagram showing a signal transmission device of a first embodiment.

FIG. 11 is a diagram showing one configuration example of a driver chip.

FIG. 12 is a diagram showing how an unintended self-diagnosis instruction appears.

FIG. 13 is a diagram showing how an unintended self-diagnosis instruction is recognized.

FIG. 14 is a diagram showing a signal transmission device of a second embodiment.

FIG. 15 is a diagram showing one example of mirror clamp operation.

FIG. 16 is a diagram showing the exterior appearance of a vehicle.

### DESCRIPTION OF EMBODIMENTS

### Signal Transmission Device (Basic Configuration)

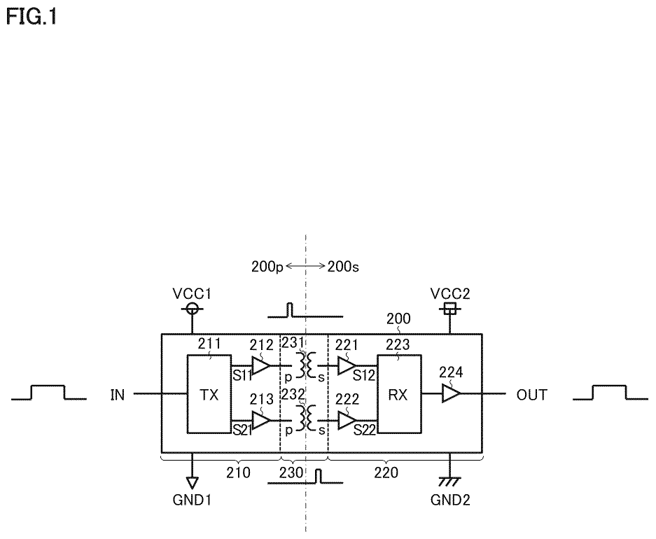

FIG. 1 is a diagram illustrating the basic configuration of a signal transmission device. The signal transmission device 200 of this configuration example is a semiconductor integrated circuit device (what is generally called an isolated gate driver IC) that, while isolating between a primary circuit system 200p (VCC1-GND1 system) and a secondary circuit system 200s (VCC2-GND2 system), transmits a pulse signal from the primary circuit system 200p to the secondary circuit system 200s to drive the gate of a switching device (unillustrated) provided in the secondary circuit system 200s. The signal transmission device 200 has, for example, a controller chip 210, a driver chip 220, and a transformer chip 230 sealed in a single package.

The controller chip 210 is a semiconductor chip that operates by being supplied with a supply voltage VCC1 (e.g., seven volts at the maximum with respect to GND1). The controller chip 210 has, for example, a pulse transmission circuit 211 and buffers 212 and 213 integrated in it.

The pulse transmission circuit 211 is a pulse generator that generates transmission pulse signals S11 and S21 according to an input pulse signal IN. More specifically, when indicating that the input pulse signal IN is at high level, the pulse transmission circuit 211 pulse-drives (outputs a single or a plurality of pulses in) the transmission pulse signal S11; when indicating that the input pulse signal IN is at low level, the pulse transmission circuit 211 pulse-drives the transmission pulse signal S21. That is, the pulse transmission circuit 211 pulse-drives either the transmission pulse signal S11 or S21 according to the logic level of the input pulse signal IN.

The buffer 212 receives the transmission pulse signal S11 from the pulse transmission circuit 211, and pulse-drives the transformer chip 230 (more specifically, a transformer 231).

The buffer 213 receives the transmission pulse signal S21 from the pulse transmission circuit 211, and pulse-drives the transformer chip 230 (more specifically, a transformer 232).

The driver chip 220 is a semiconductor chip that operates by being supplied with a supply voltage VCC2 (e.g., 30 volts at the maximum with respect to GND2). The driver chip 220 has, for example, buffers 221 and 222, a pulse reception circuit 223, and a driver 224 integrated in it.

The buffer 221 performs waveform shaping on a reception pulse signal S12 induced in the transformer chip 230 (specifically, the transformer 231), and outputs the result to the pulse reception circuit 223.

The buffer 222 performs waveform shaping on a reception pulse signal S22 induced in the transformer chip 230 (specifically, the transformer 232), and outputs the result to the pulse reception circuit 223.

According to the reception pulse signals S12 and S22 fed to it via the buffers 221 and 222, the pulse reception circuit 223 drives the driver 224 to generate an output pulse signal OUT. More specifically, the pulse reception circuit 223 drives the driver 224 to raise the output pulse signal OUT to high level in response to the reception pulse signal S12 being pulse-driven and to drop the output pulse signal OUT to low level in response to the reception pulse signal S22 being pulse-driven. That is, the pulse reception circuit 223 switches the logic level of the output pulse signal OUT according to the logic level of the input pulse signal IN. As the pulse reception circuit 223, for example, an RS flip-flop can be suitably used.

The driver 224 generates the output pulse signal OUT under the driving and control of the pulse reception circuit 223.

The transformer chip 230, while isolating between the controller chip 210 and the driver chip 220 on a direct-current basis using the transformers 231 and 232, outputs the transmission pulse signals S11 and S21 fed to the transformer chip 230 from the pulse transmission circuit 211 to, as the reception pulse signals S12 and S22, the pulse reception circuit 223. In the present description, “isolating on a direct-current basis” means leaving two elements to be isolated from each other unconnected by a conductor.

More specifically, the transformer 231 outputs, according to the transmission pulse signal S11 fed to the primary coil 231p, the reception pulse signal S12 from the secondary coil 231s. Likewise, the transformer 232 outputs, according to the transmission pulse signal S21 fed to the primary coil 232p, the reception pulse signal S22 from the secondary coil 232s.

In this way, owing to the characteristics of spiral coils used in isolated communication, the input pulse signal IN is split into two transmission pulse signals S11 and S21 (corresponding to a rise signal and a fall signal) to be transmitted via the two transformers 231 and 232 from the primary circuit system 200p to the secondary circuit system 200s.

Note that the signal transmission device 200 of this configuration example has, separately from the controller chip 210 and the driver chip 220, the transformer chip 230 that incorporates the transformers 231 and 232 alone, and those three chips are sealed in a single package.

With this configuration, the controller chip 210 and the driver chip 220 can each be formed by a common low-to middle-withstand-voltage process (with a withstand voltage of several volts to several tens of volts). This eliminates the need for a dedicated high-withstand-voltage process (with a withstand voltage of several kilovolts), and helps reduce manufacturing costs.

The signal transmission device 200 can be employed suitably, for example, in a power supply device or motor driving device in a vehicle-mounted device incorporated in a vehicle. Such a vehicle can be an engine vehicle or an electric vehicle (an xEV such as a BEV [battery electric vehicle], HEV [hybrid electric vehicle], PHEV/PHV [plug-in hybrid electric vehicle/plug-in hybrid vehicle], or FCEV/FCV [fuel cell electric vehicle/fuel cell vehicle]).

### Transformer Chip (Basic Structure)

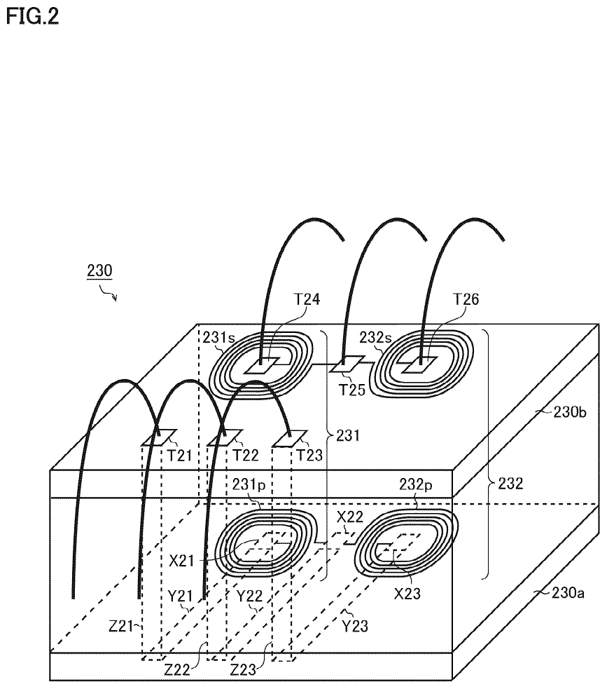

Next, the basic structure of the transformer chip 230 will be described. FIG. 2 is a diagram showing the basic structure of the transformer chip 230. In the transformer chip 230 shown there, the transformer 231 includes a primary coil 231p and a secondary coil 231s that face each other in the up-down direction; the transformer 232 includes a primary coil 232p and a secondary coil 232s that face each other in the up-down direction.

The primary coils 231p and 232p are both formed in a first wiring layer (lower layer) 230a in the transformer chip 230. The secondary coils 231s and 232s are both formed in a second wiring layer (the upper layer in the diagram) 230b in the transformer chip 230. The secondary coil 231s is disposed right above the primary coil 231p and faces the primary coil 231p; the secondary coil 232s is disposed right above the primary coil 232p and faces the primary coil 232p.

The primary coil 231p is laid in a spiral shape so as to encircle an internal terminal X21 clockwise, starting at the first terminal of the primary coil 231p, which is connected to the internal terminal X21. The second terminal of the primary coil 231p, which corresponds to its end point, is connected to an internal terminal X22. Likewise, the primary coil 232p is laid in a spiral shape so as to encircle an internal terminal X23 anticlockwise, starting at the first terminal of the primary coil 232p, which is connected to the internal terminal X23. The second terminal of the primary coil 232p, which corresponds to its end point, is connected to the internal terminal X22. The internal terminals X21, X22, and X23 are arrayed on a straight line in the illustrated order.

The internal terminal X21 is connected, via a wiring Y21 and a via Z21 both conductive, to an external terminal T21 in the second layer 230b. The internal terminal X22 is connected, via a wiring Y22 and a via Z22 both conductive, to an external terminal T22 in the second layer 230b. The internal terminal X23 is connected, via a wiring Y23 and a via Z23 both conductive, to an external terminal T23 in the second layer 230b. The external terminals T21 to T23 are disposed in a straight row and are used for wire-bonding with the controller chip 210.

The secondary coil 231s is laid in a spiral shape so as to encircle an external terminal T24 anticlockwise, starting at the first terminal of the secondary coil 231s, which is connected to the external terminal T24. The second terminal of the secondary coil 231s, which corresponds to its end point, is connected to an external terminal T25. Likewise, the secondary coil 232s is laid in a spiral shape so as to encircle an external terminal T26 clockwise, starting at the first terminal of the secondary coil 232s, which is connected to the external terminal T26. The second terminal of the secondary coil 232s, which corresponds to its end point, is connected to the external terminal T25. The external terminals T24, T25, and T26 are disposed in a straight row in the illustrated order and are used for wire-bonding with the driver chip 220.

The secondary coils 231s and 232s are AC-connected to the primary coils 231p and 232p, respectively, by magnetic coupling, and are DC-isolated from the primary coils 231p and 232p. That is, the driver chip 220 is AC-connected to the controller chip 210 via the transformer chip 230 and is DC-isolated from the controller chip 210 by the transformer chip 230.

### Transformer Chip (Two-Channel Type)

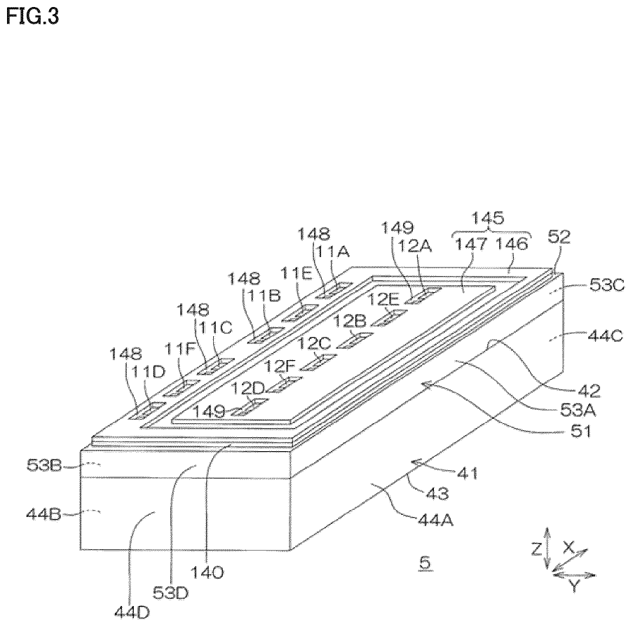

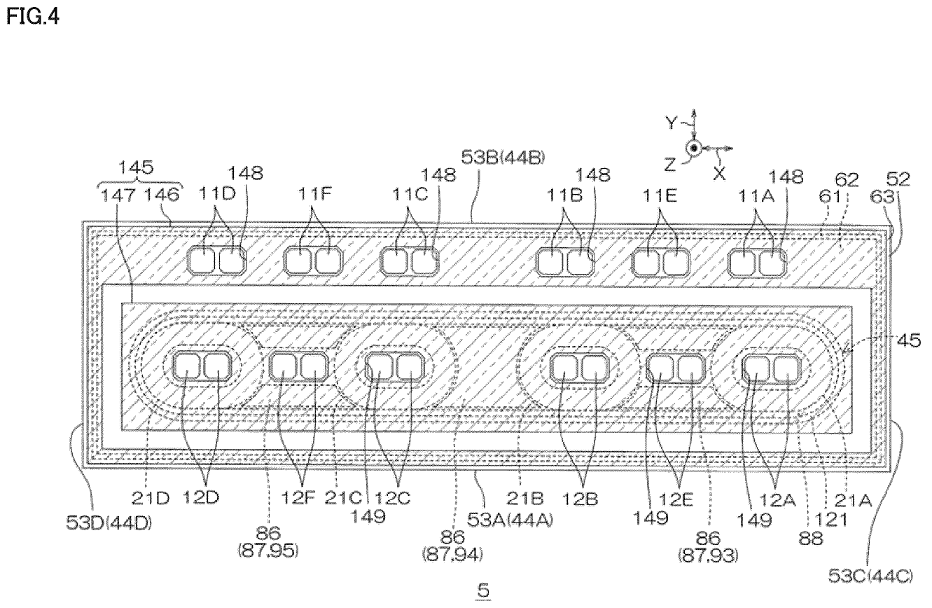

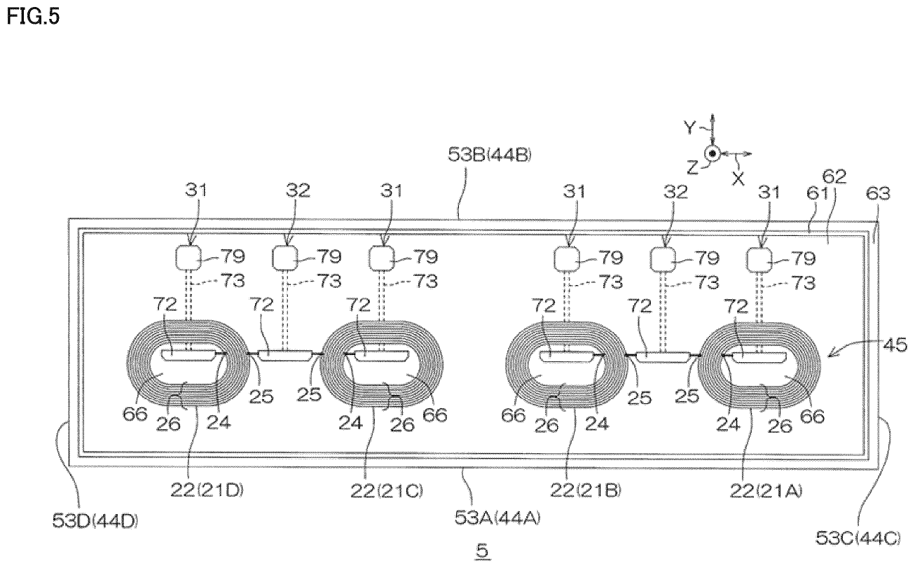

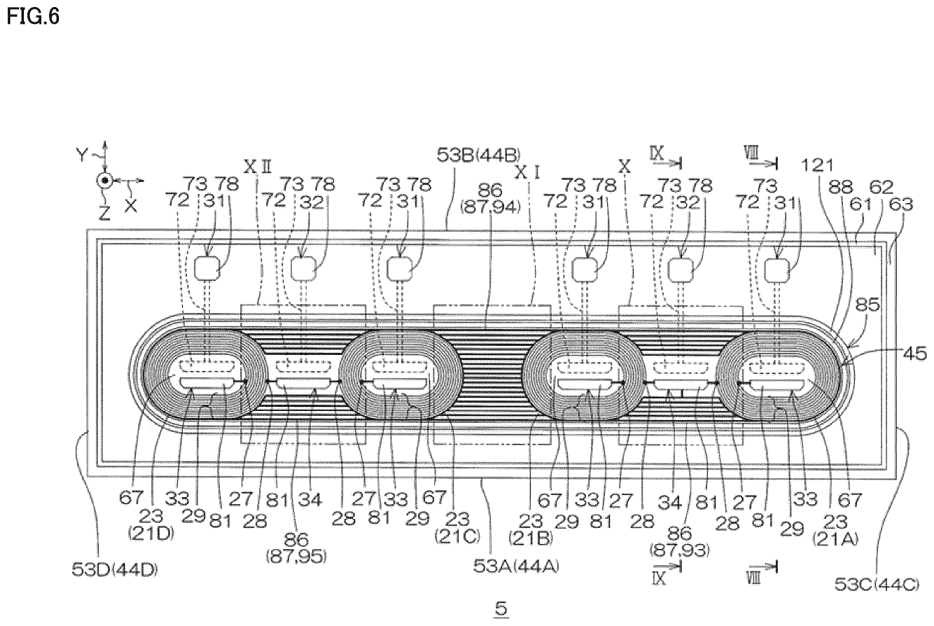

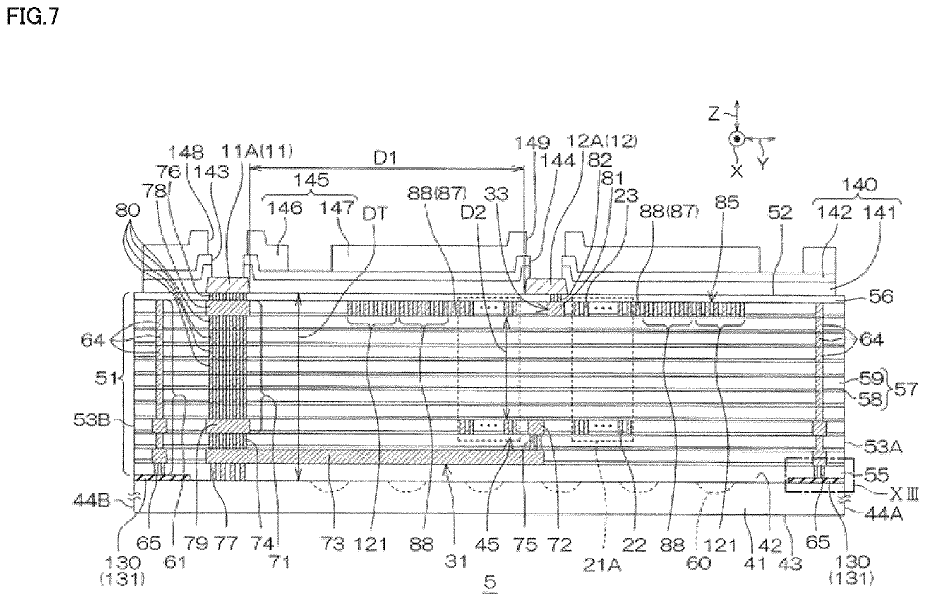

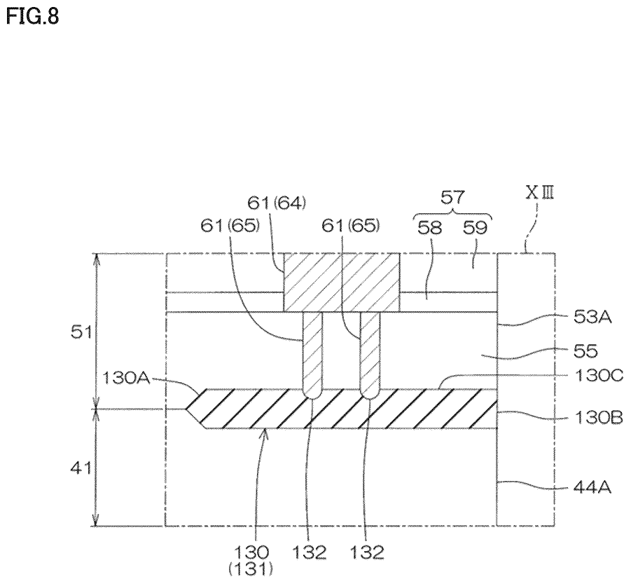

FIG. 3 is a perspective view of a semiconductor device 5 used as a two-channel transformer chip. FIG. 4 is a plan view of the semiconductor device 5 shown in FIG. 3. FIG. 5 is a plan view showing a layer in the semiconductor device 5 shown in FIG. 3 where low-potential coils 22 (corresponding to the primary coils of transformers) are formed. FIG. 6 is a plan view showing a layer in the semiconductor device 5 shown in FIG. 3 where high-potential coils 23 (corresponding to the secondary coils of transformers) are formed. FIG. 7 is a sectional view along line VIII-VIII shown in FIG. 6. FIG. 8 is an enlarged view of region XIII shown in FIG. 7, which shows a separation structure 130.

Referring to FIGS. 3 to FIG. 7, the semiconductor device 5 includes a semiconductor chip 41 in the shape of a rectangular parallelepiped. The semiconductor chip 41 contains at least one of silicon, a wide band gap semiconductor, and a compound semiconductor.

The wide band gap semiconductor is a semiconductor with a band gap larger than that of silicon (about 1.12 eV). Preferably, the wide band gap semiconductor has a band gap of 2.0 eV or more. The wide band gap semiconductor can be SiC (silicon carbide). The compound semiconductor can be a III-V group compound semiconductor. The compound semiconductor can contain at least one of aluminum nitride (AlN), indium nitride (InN), gallium nitride (GaN), and gallium arsenide (GaAs).

In the embodiment, the semiconductor chip 41 includes a semiconductor substrate made of silicon. The semiconductor chip 41 can be an epitaxial substrate that has a stacked structure composed of a semiconductor substrate made of silicon and an epitaxial layer made of silicon. The semiconductor substrate can be of an n-type or p-type conductivity. The epitaxial layer can be of an n-type or p-type.

The semiconductor chip 41 has a first principal surface 42 at one side, a second principal surface 43 at the other side, and chip side walls 44A to 44D that connect the first and second principal surfaces 42 and 43 together. As seen in a plan view from the normal direction Z to them (hereinafter simply expressed as “as seen in a plan view”), the first and second principal surfaces 42 and 43 are each formed in a quadrangular shape (in the embodiment, in a rectangular shape).

The chip side walls 44A to 44D include a first chip side wall 44A, a second chip side wall 44B, a third chip side wall 44C, and a fourth chip side wall 44D. The first and second chip side walls 44A and 44B constitute the longer sides of the semiconductor chip 41. The first and second chip side walls 44A and 44B extend along a first direction X and face away from each other in a second direction Y. The third and fourth chip side walls 44C and 44D constitute the shorter sides of the semiconductor chip 41. The third and fourth chip side walls 44C and 44D extend in the second direction Y and face away from each other in the first direction X. The chip side walls 44A to 44D have polished surfaces.

The semiconductor device 5 further includes an insulation layer 51 formed on the first principal surface 42 of the semiconductor chip 41. The insulation layer 51 has an insulation principal surface 52 and insulation side walls 53A to 53D. The insulation principal surface 52 is formed in a quadrangular shape (in the embodiment, a rectangular shape) that fits the first principal surface 42 as seen in a plan view. The insulation principal surface 52 extends parallel to the first principal surface 42.

The insulation side walls 53A to 53D include a first insulation side wall 53A, a second insulation side wall 53B, a third insulation side wall 53C, and a fourth insulation side wall 53D. The insulation side walls 53A to 53D extend from the circumferential edge of the insulation principal surface 52 toward the semiconductor chip 41 and are continuous with the chip side walls 44A to 44D. Specifically, the insulation side walls 53A to 53D are formed to be flush with the chip side walls 44A to 44D. The insulation side walls 53A to 53D constitute polished surfaces that are flush with the chip side walls 44A to 44D.

The insulation layer 51 has a stacked structure of multilayer insulation layers that include a bottom insulation layer 55, a top insulation layer 56, and a plurality of (in the embodiment, eleven) interlayer insulation layers 57. The bottom insulation layer 55 is an insulation layer that directly covers the first principal surface 42. The top insulation layer 56 is an insulation layer that constitutes the insulation principal surface 52. The plurality of interlayer insulation layers 57 are insulation layers that are interposed between the bottom and top insulation layers 55 and 56. In the embodiment, the bottom insulation layer 55 has a single-layer structure that contains silicon oxide. In the embodiment, the top insulation layer 56 has a single-layer structure that contains silicon oxide. The bottom and top insulation layers 55 and 56 can each have a thickness of 1 μm or more but 3 μm or less (e.g., about 2 μm).

The plurality of interlayer insulation layers 57 each have a stacked structure that includes a first insulation layer 58 at the bottom insulation layer 55 side and a second insulation layer 59 at the top insulation layer 56 side. The first insulation layer 58 can contain silicon nitride. The first insulation layer 58 is formed as an etching stopper layer for the second insulation layer 59. The first insulation layer 58 can have a thickness of 0.1 μm or more but 1 μm or less (e.g., about 0.3 μm).

The second insulation layer 59 is formed on top of the first insulation layer 58 and contains an insulating material different from that of the first insulation layer 58. The second insulation layer 59 can contain silicon oxide. The second insulation layer 59 can have a thickness of 1 μm or more but 3 μm or less (e.g., about 2 μm). Preferably, the second insulation layer 59 is given a thickness larger than that of the first insulation layer 58.

The insulation layer 51 can have a total thickness DT of 5 μm or more but 50 μm or less. The insulation layer 51 can have any total thickness DT and any number of interlayer insulation layers 57 stacked together, which are adjusted according to the desired dielectric strength voltage (dielectric breakdown withstand voltage). The bottom insulation layer 55, the top insulation layer 56, and the interlayer insulation layers 57 can employ any insulating material, which is thus not limited to any particular insulating material.

The semiconductor device 5 includes a first functional device 45 formed in the insulation layer 51. The first functional device 45 includes one or a plurality of (in the embodiment, a plurality of) transformers 21 (corresponding to the transformers mentioned previously). That is, the semiconductor device 5 is a multichannel device that includes a plurality of transformers 21. The plurality of transformers 21 are formed in an inner part of the insulation layer 51, at intervals from the insulation side walls 53A to 53D. The plurality of transformers 21 are formed at intervals from each other in the first direction X. Specifically, the plurality of transformers 21 include a first transformer 21A, a second transformer 21B, a third transformer 21C, and a fourth transformer 21D that are formed in this order from the insulation side wall 53C side to the insulation side wall 53D side as seen in a plan view. The plurality of transformers 21A to 21D have similar structures. In the following description, the structure of the first transformer 21A will be described as an example. No separate description will be given of the structures of the second, third, and fourth transformers 21B, 21C, and 21D, to which the description of the structure of the first transformer 21A is to be taken to apply.

Referring to FIGS. 5 to FIG. 7, the first transformer 21A includes a low-potential coil 22 and a high-potential coil 23. The low-potential coil 22 is formed in the insulation layer 51. The high-potential coil 23 is formed in the insulation layer 51 so as to face the low-potential coil 22 in the normal direction Z. In the embodiment, the low- and high-potential coils 22 and 23 are formed in a region between the bottom and top insulation layers 55 and 56 (i.e., in the plurality of interlayer insulation layers 57).

The low-potential coil 22 is formed in the insulation layer 51, at the bottom insulation layer 55 (semiconductor chip 41) side, and the high-potential coil 23 is formed in the insulation layer 51, at the top insulation layer 56 (insulation principal surface 52) side with respect to the low-potential coil 22. That is, the high-potential coil 23 faces the semiconductor chip 41 across the low-potential coil 22. The low- and high-potential coils 22 and 23 can be disposed at any places. The high-potential coil 23 can face the low-potential coil 22 across one or more interlayer insulation layers 57.

The distance between the low- and high-potential coils 22 and 23 (i.e., the number of interlayer insulation layers 57 stacked together) is adjusted appropriately according to the dielectric strength voltage and electric field strength between the low- and high-potential coils 22 and 23. In the embodiment, the low-potential coil 22 is formed in the third interlayer insulation layer 57 as counted from the bottom insulation layer 55 side. In the embodiment, the high-potential coil 23 is formed in the first interlayer insulation layer 57 as counted from the top insulation layer 56 side.

The low-potential coil 22 is embedded in the interlayer insulation layer 57 so as to penetrate the first and second insulation layers 58 and 59. The low-potential coil 22 includes a first inner end 24, a first outer end 25, and a first spiral portion 26 that is patterned in a spiral shape between the first inner and outer ends 24 and 25. The first spiral portion 26 is patterned in a spiral shape that extends in an elliptical (oval) shape as seen in a plan view. The part of the first spiral portion 26 that forms its inner circumferential edge defines a first inner region 66 that is in an elliptical shape as seen in a plan view.

The first spiral portion 26 can have a number of turns of 5 or more but 30 or less. The first spiral portion 26 can have a width of 0.1 μm or more but 5 μm or less. Preferably, the first spiral portion 26 has a width of 1 μm or more but 3 μm or less. The width of the first spiral portion 26 is defined by its width in the direction orthogonal to the spiraling direction. The first spiral portion 26 has a first winding pitch of 0.1 μm or more but 5 μm or less. Preferably, the first winding pitch is 1 μm or more but 3 μm or less. The first winding pitch is defined by the distance between two parts of the first spiral portion 26 that are adjacent to each other in the direction orthogonal to the spiraling direction.

The first spiral portion 26 can have any winding shape and the first inner region 66 can have any planar shape, which are thus not limited to those shown in FIG. 5 etc. The first spiral portion 26 can be wound in a polygonal shape, such as a triangular or quadrangular shape, or in a circular shape as seen in a plan view. The first inner region 66 can be defined, so as to fit the winding shape of the first spiral portion 26, in a polygonal shape, such as a triangular or quadrangular shape, or in a circular shape as seen in a plan view.

The low-potential coil 22 can contain at least one of titanium, titanium nitride, copper, aluminum, and tungsten. The low-potential coil 22 can have a stacked structure composed of a barrier layer and a body layer. The barrier layer defines a recessed space in the interlayer insulation layer 57. The barrier layer can contain at least one of titanium and titanium nitride. The body layer can contain at least one of copper, aluminum, and tungsten.

The high-potential coil 23 is embedded in the interlayer insulation layer 57 so as to penetrate the first and second insulation layers 58 and 59. The high-potential coil 23 includes a second inner end 27, a second outer end 28, and a second spiral portion 29 that is patterned in a spiral shape between the second inner and outer ends 27 and 28. The second spiral portion 29 is patterned in a spiral shape that extends in an elliptical (oval) shape as seen in a plan view. The part of the second spiral portion 29 that forms its inner circumferential edge defines a second inner region 67 that is in an elliptical shape as seen in a plan view in the embodiment. The second inner region 67 in the second spiral portion 29 faces the first inner region 66 in the first spiral portion 26 in the normal direction Z.

The second spiral portion 29 can have a number of turns of 5 or more but 30 or less. The number of turns of the second spiral portion 29 relative to that of the first spiral portion 26 is adjusted according to the target value of voltage boosting. Preferably, the number of turns of the second spiral portion 29 is larger than that of the first spiral portion 26. Needless to say, the number of turns of the second spiral portion 29 can be smaller than or equal to that of the first spiral portion 26.

The second spiral portion 29 can have a width of 0.1 μm or more but 5 μm or less. Preferably, the second spiral portion 29 has a width of 1 μm or more but 3 μm or less. The width of the second spiral portion 29 is defined by its width in the direction orthogonal to the spiraling direction. Preferably, the width of the second spiral portion 29 is equal to the width of the first spiral portion 26.

The second spiral portion 29 can have a second winding pitch of 0.1 μm or more but 5 μm or less. Preferably, the second winding pitch is 1 μm or more but 3 μm or less. The second winding pitch is defined by the distance between two parts of the second spiral portion 29 that are adjacent to each other in the direction orthogonal to the spiraling direction. Preferably, the second winding pitch is equal to the first winding pitch of the first spiral portion 26.

The second spiral portion 29 can have any winding shape and the second inner region 67 can have any planar shape, which are thus not limited to those shown in FIG. 6 etc. The second spiral portion 29 can be wound in a polygonal shape, such as a triangular or quadrangular shape, or in a circular shape as seen in a plan view. The second inner region 67 can be defined, so as to fit the winding shape of the second spiral portion 29, in a polygonal shape, such as a triangular or quadrangular shape, or in a circular shape as seen in a plan view.

Preferably, the high-potential coil 23 is formed of the same conductive material as the low-potential coil 22. That is, preferably, like the low-potential coil 22, the high-potential coil 23 includes a barrier layer and a body layer.

Referring to FIG. 4, the semiconductor device 5 includes a plurality of (in the diagram, twelve) low-potential terminals 11 and a plurality of (in the diagram, twelve) high-potential terminals 12. The plurality of low-potential terminals 11 are electrically connected to the low-potential coils 22 of the corresponding transformers 21A to 21D respectively. The plurality of high-potential terminals 12 are electrically connected to the high-potential coils 23 of the corresponding transformers 21A to 21D respectively.

The plurality of low-potential terminals 11 are formed on the insulation principal surface 52 of the insulation layer 51. Specifically, the plurality of low-potential terminals 11 are formed in a second insulation side wall 53B side region, at an interval from the plurality of transformers 21A to 21D in the second direction Y, and are arrayed at intervals from each other in the first direction X.

The plurality of low-potential terminals 11 include a first low-potential terminal 11A, a second low-potential terminal 11B, a third low-potential terminal 11C, a fourth low-potential terminal 11D, a fifth low-potential terminal 11E, and a sixth low-potential terminal 11F. Actually, in the embodiment, two each of the plurality of low-potential terminals 11A to 11F are formed. The plurality of low-potential terminals 11A to 11F may each include any number of terminals.

The first low-potential terminal 11A faces the first transformer 21A in the second direction Y as seen in a plan view. The second low-potential terminal 11B faces the second transformer 21B in the second direction Y as seen in a plan view. The third low-potential terminal 11C faces the third transformer 21C in the second direction Y as seen in a plan view. The fourth low-potential terminal 11D faces the fourth transformer 21D in the second direction Y as seen in a plan view. The fifth low-potential terminal 11E is formed in a region between the first and second low-potential terminals 11A and 11B as seen in a plan view. The sixth low-potential terminal 11F is formed in a region between the third and fourth low-potential terminals 11C and 11D as seen in a plan view.

The first low-potential terminal 11A is electrically connected to the first inner end 24 of the first transformer 21A (low-potential coil 22). The second low-potential terminal 11B is electrically connected to the first inner end 24 of the second transformer 21B (low-potential coil 22). The third low-potential terminal 11C is electrically connected to the first inner end 24 of the third transformer 21C (low-potential coil 22). The fourth low-potential terminal 11D is electrically connected to the first inner end 24 of the fourth transformer 21D (low-potential coil 22).

The fifth low-potential terminal 11E is electrically connected to the first outer end 25 of the first transformer 21A (low-potential coil 22) and to the first outer end 25 of the second transformer 21B (low-potential coil 22). The sixth low-potential terminal 11F is electrically connected to the first outer end 25 of the third transformer 21C (low-potential coil 22) and to the first outer end 25 of the fourth transformer 21D (low-potential coil 22).

The plurality of high-potential terminals 12 are formed on the insulation principal surface 52 of the insulation layer 51, at an interval from the plurality of low-potential terminals 11. Specifically, the plurality of high-potential terminals 12 are formed in a first insulation side wall 53A side region, at an interval from the plurality of low-potential terminals 11 in the second direction Y, and are arrayed at intervals from each other in the first direction X.

The plurality of high-potential terminals 12 are formed in regions close to the corresponding transformers 21A to 21D, respectively, as seen in a plan view. The high-potential terminals 12 being close to the transformers 21A to 21D means that, as seen in a plan view, the distance between the high-potential terminals 12 and the transformers 21 is smaller than the distance between the low-potential terminals 11 and the high-potential terminals 12.

Specifically, as seen in a plan view, the plurality of high-potential terminals 12 are formed at intervals from each other along the first direction X so as to face the plurality of transformers 21A to 21D along the first direction X. More specifically, as seen in a plan view, the plurality of high-potential terminals 12 are formed at intervals from each other along the first direction X so as to be located in the second inner regions 67 in the high-potential coils 23 and in regions between adjacent high-potential coils 23. As a result, as seen in a plan view, the plurality of high-potential terminals 12 are, along with the transformers 21A to 21D, arrayed in one row along the first direction X.

The plurality of high-potential terminals 12 include a first high-potential terminal 12A, a second high-potential terminal 12B, a third high-potential terminal 12C, a fourth high-potential terminal 12D, a fifth high-potential terminal 12E, and a sixth high-potential terminal 12F. Actually, in the embodiment, two each of the plurality of high-potential terminals 12A to 12F are formed. The plurality of high-potential terminals 12A to 12F may each include any number of terminals.

The first high-potential terminal 12A is formed in the second inner region 67 in the first transformer 21A (high-potential coil 23) as seen in a plan view. The second high-potential terminal 12B is formed in the second inner region 67 in the second transformer 21B (high-potential coil 23) as seen in a plan view. The third high-potential terminal 12C is formed in the second inner region 67 in the third transformer 21C (high-potential coil 23) as seen in a plan view. The fourth high-potential terminal 12D is formed in the second inner region 67 in the fourth transformer 21D (high-potential coil 23) as seen in a plan view. The fifth high-potential terminal 12E is formed in a region between the first and second transformers 21A and 21B as seen in a plan view. The sixth high-potential terminal 12F is formed in a region between the third and fourth transformers 21C and 21D as seen in a plan view.

The first high-potential terminal 12A is electrically connected to the second inner end 27 of the first transformer 21A (high-potential coil 23). The second high-potential terminal 12B is electrically connected to the second inner end 27 of the second transformer 21B (high-potential coil 23). The third high-potential terminal 12C is electrically connected to the second inner end 27 of the third transformer 21C (high-potential coil 23). The fourth high-potential terminal 12D is electrically connected to the second inner end 27 of the fourth transformer 21D (high-potential coil 23).

The fifth high-potential terminal 12E is electrically connected to the second outer end 28 of the first transformer 21A (high-potential coil 23) and to the second outer end 28 of the second transformer 21B (high-potential coil 23). The sixth high-potential terminal 12F is electrically connected to the second outer end 28 of the third transformer 21C (high-potential coil 23) and to the second outer end 28 of the fourth transformer 21D (high-potential coil 23).

Referring to FIG. 5 and FIG. 7, the semiconductor device 5 includes a first low-potential wiring 31, a second low-potential wiring 32, a first high-potential wiring 33, and a second high-potential wiring 34, all formed in the insulation layer 51. Actually, in the embodiment, a plurality of first low-potential wirings 31, a plurality of second low-potential wirings 32, a plurality of first high-potential wirings 33, and a plurality of second high-potential wirings 34 are formed.

The first and second low-potential wirings 31 and 32 hold the low-potential coils 22 of the first and second transformers 21A and 21B at equal potentials. The first and second low-potential wirings 31 and 32 also hold the low-potential coils 22 of the third and fourth transformers 21C and 21D at equal potentials. In the embodiment, the first and second low-potential wirings 31 and 32 hold the low-potential coils 22 of all the transformers 21A to 21D at equal potentials.

The first and second high-potential wirings 33 and 34 hold the high-potential coils 23 of the first and second transformers 21A and 21B at equal potentials. The first and second high-potential wirings 33 and 34 also hold the high-potential coils 23 of the third and fourth transformers 21C and 21D at equal potentials. In the embodiment, the first and second high-potential wirings 33 and 34 hold the high-potential coils 23 of all the transformers 21A to 21D at equal potentials.

The plurality of first low-potential wirings 31 are electrically connected respectively to the corresponding low-potential terminals 11A to 11D and to the first inner ends 24 of the corresponding transformers 21A to 21D (low-potential coils 22). The plurality of first low-potential wirings 31 have similar structures. In the following description, the structure of the first low-potential wiring 31 connected to the first low-potential terminal 11A and to the first transformer 21A will be described as an example. No separate description will be given of the structures of the other first low-potential wirings 31, to which the description of the structure of the first low-potential wiring 31 connected to the first transformer 21A is to be taken to apply.

The first low-potential wiring 31 includes a through wiring 71, a low-potential connection wiring 72, a lead wiring 73, a first connection plug electrode 74, a second connection plug electrode 75, one or a plurality of (in this embodiment, a plurality of) pad plug electrodes 76, and one or a plurality of (in this embodiment, a plurality of) substrate plug electrodes 77.

Preferably, the through wiring 71, the low-potential connection wiring 72, the lead wiring 73, the first connection plug electrode 74, the second connection plug electrode 75, the pad plug electrodes 76, and the substrate plug electrodes 77 are formed of the same conductive material as the low-potential coil 22 and the like. That is, preferably, like the low-potential coil 22 and the like, the through wiring 71, the low-potential connection wiring 72, the lead wiring 73, the first connection plug electrode 74, the second connection plug electrode 75, the pad plug electrodes 76, and the substrate plug electrodes 77 each include a barrier layer and a body layer.

The through wiring 71 penetrates a plurality of interlayer insulation layers 57 in the insulation layer 51 and extends in a columnar shape along the normal direction Z. In the embodiment, the through wiring 71 is formed in a region between the bottom and top insulation layers 55 and 56 in the insulation layer 51. The through wiring 71 has a top end part at the top insulation layer 56 side and a bottom end part at the bottom insulation layer 55 side. The top end part of the through wiring 71 is formed in the same interlayer insulation layer 57 as the high-potential coil 23 and is covered by the top insulation layer 56. The bottom end part of the through wiring 71 is formed in the same interlayer insulation layer 57 as the low-potential coil 22.

In the embodiment, the through wiring 71 includes a first electrode layer 78, a second electrode layer 79, and a plurality of wiring plug electrodes 80. In the through wiring 71, the first and second electrode layers 78 and 79 and the wiring plug electrodes 80 are formed of the same conductive material as the low-potential coil 22 and the like. That is, like the low-potential coil 22 and the like, the first and second electrode layers 78 and 79 and the wiring plug electrodes 80 each include a barrier layer and a body layer.

The first electrode layer 78 constitutes the top end part of the through wiring 71. The second electrode layer 79 constitutes the bottom end part of the through wiring 71. The first electrode layer 78 is formed as an island, and faces the low-potential terminal 11 (first low-potential terminal 11A) in the normal direction Z. The second electrode layer 79 is formed as an island, and faces the first electrode layer 78 in the normal direction Z.

The plurality of wiring plug electrodes 80 are embedded respectively in the plurality of interlayer insulation layers 57 located in a region between the first and second electrode layers 78 and 79. The plurality of wiring plug electrodes 80 are stacked together from the bottom insulation layer 55 to the top insulation layer 56 so as to be electrically connected together, and electrically connect together the first and second electrode layers 78 and 79. The plurality of wiring plug electrodes 80 each have a plane area smaller than the plane area of either of the first and second electrode layers 78 and 79.

The number of layers stacked in the plurality of wiring plug electrodes 80 is equal to the number of layers stacked in the plurality of interlayer insulation layers 57. In the embodiment, six wiring plug electrodes 80 are embedded in interlayer insulation layers 57 respectively, and any number of wiring plug electrodes 80 can be embedded in interlayer insulation layers 57 respectively. Needless to say, one or a plurality of wiring plug electrodes 80 can be formed that penetrates a plurality of interlayer insulation layers 57.

The low-potential connection wiring 72 is formed in the same interlayer insulation layer 57 as the low-potential coil 22, in the first inner region 66 in the first transformer 21A (low-potential coil 22). The low-potential connection wiring 72 is formed as an island and faces the high-potential terminal 12 (first high-potential terminal 12A) in the normal direction Z. Preferably, the low-potential connection wiring 72 has a plane area larger than the plane area of the wiring plug electrode 80. The low-potential connection wiring 72 is electrically connected to the first inner end 24 of the low-potential coil 22.

The lead wiring 73 is formed in the interlayer insulation layer 57, in a region between the semiconductor chip 41 and the through wiring 71. In the embodiment, the lead wiring 73 is formed in the first interlayer insulation layer 57 as counted from the bottom insulation layer 55. The lead wiring 73 has a first end part at one side, a second end part at the other side, and a wiring part that connects together the first and second end parts. The first end part of the lead wiring 73 is located in a region between the semiconductor chip 41 and the bottom end part of the through wiring 71. The second end part of the lead wiring 73 is located in a region between the semiconductor chip 41 and the low-potential connection wiring 72. The wiring part extends along the first principal surface 42 of the semiconductor chip 41, and extends in the shape of a stripe in a region between the first and second end parts.

The first connection plug electrode 74 is formed in the interlayer insulation layer 57, in a region between the through wiring 71 and the lead wiring 73, and is electrically connected to the through wiring 71 and to the first end part of the lead wiring 73. The second connection plug electrode 75 is formed in the interlayer insulation layer 57, in a region between the low-potential connection wiring 72 and the lead wiring 73 and is electrically connected to the low-potential connection wiring 72 and to the second end part of the lead wiring 73.

The plurality of pad plug electrodes 76 are formed in the top insulation layer 56, in a region between the low-potential terminal 11 (first low-potential terminal 11A) and the through wiring 71, and are electrically connected to the low-potential terminal 11 and to the top end part of the through wiring 71. The plurality of substrate plug electrodes 77 are formed in the bottom insulation layer 55, in a region between the semiconductor chip 41 and the lead wiring 73. In the embodiment, the substrate plug electrodes 77 are formed in a region between the semiconductor chip 41 and the first end part of the lead wiring 73, and are electrically connected to the semiconductor chip 41 and to the first end part of the lead wiring 73.

Referring to FIG. 6 and FIG. 7, the plurality of first high-potential wirings 33 are connected respectively to the corresponding high-potential terminals 12A to 12D and to the second inner ends 27 of the corresponding transformers 21A to 21D (high-potential coils 23). The plurality of first high-potential wirings 33 have similar structures. In the following description, the structure of the first high-potential wiring 33 connected to the first high-potential terminal 12A and to the first transformer 21A will be described as an example. No description will be given of the structures of the other first high-potential wirings 33, to which the description of the structure of the first high-potential wiring 33 connected to the first transformer 21A is to be taken to apply.

The first high-potential wiring 33 includes a high-potential connection wiring 81 and one or a plurality of (in this embodiment, a plurality of) pad plug electrodes 82. Preferably, the high-potential connection wiring 81 and the pad plug electrodes 82 are formed of the same conductive material as the low-potential coil 22 and the like. That is, preferably, like the low-potential coil 22 and the like, the high-potential connection wiring 81 and the pad plug electrodes 82 each include a barrier layer and a body layer.

The high-potential connection wiring 81 is formed in the same interlayer insulation layer 57 as the high-potential coil 23, in the second inner region 67 in the high-potential coil 23. The high-potential connection wiring 81 is formed as an island, and faces the high-potential terminal 12 (first high-potential terminal 12A) in the normal direction Z. The high-potential connection wiring 81 is electrically connected to the second inner end 27 of the high-potential coil 23. The high-potential connection wiring 81 is formed at an interval from the low-potential connection wiring 72 as seen in a plan view, and does not face the low-potential connection wiring 72 in the normal direction Z. This results in an increased insulation distance between the low- and high-potential connection wirings 72 and 81 and hence an increased dielectric strength voltage in the insulation layer 51.

The plurality of pad plug electrodes 82 are formed in the top insulation layer 56, in a region between the high-potential terminal 12 (first high-potential terminal 12A) and the high-potential connection wiring 81, and are electrically connected to the high-potential terminal 12 and to the high-potential connection wiring 81. The plurality of pad plug electrodes 82 each have a plane area smaller than the plane area of the high-potential connection wiring 81 as seen in a plan view.

Referring to FIG. 7, preferably, the distance D1 between the low- and high-potential terminals 11 and 12 is larger than the distance D2 between the low- and high-potential coils 22 and 23 (D2<D1). Preferably, the distance D1 is larger than the total thickness DT of the plurality of interlayer insulation layers 57 (DT<D1). The ratio D2/D1 of the distance D2 to the distance D1 can be 0.01 or more but 0.1 or less. Preferably, the distance D1 is 100 μm or more but 500 μm or less. The distance D2 can be 1 μm or more but 50 μm or less. Preferably, the distance D2 is 5 μm or more but 25 μm or less. The distances D1 and D2 can have any values, which are adjusted appropriately according to the desired dielectric strength voltage.

Referring to FIG. 6 and FIG. 7, the semiconductor device 5 has a dummy pattern 85 that is embedded in the insulation layer 51 so as to be located around the transformers 21A to 21D as seen in a plan view.

The dummy pattern 85 is formed in a pattern different (discontinuous) from that of either of the high- and low-potential coils 23 and 22, and is independent of the transformers 21A to 21D. That is, the dummy pattern 85 does not function as part of the transformers 21A to 21D. The dummy pattern 85 is formed as a shield conductor layer that shields electric fields between the low- and high-potential coils 22 and 23 in the transformers 21A to 21D to suppress electric field concentration on the high-potential coil 23. In the embodiment, the dummy pattern 85 is patterned at a line density per unit area that is equal to the line density of the high-potential coil 23. The line density of the dummy pattern 85 being equal to the line density of the high-potential coil 23 means that the line density of the dummy pattern 85 falls within the range of ±20% of the line density of the high-potential coil 23.

The dummy pattern 85 can be formed at any depth in the insulation layer 51, which is adjusted according to the electric field strength to be attenuated. Preferably, the dummy pattern 85 is formed in a region closer to the high-potential coil 23 than to the low-potential coil 22 with respect to the normal direction Z. The dummy pattern 85 being closer to the high-potential coil 23 with respect to the normal direction Z means that, with respect to the normal direction Z, the distance between the dummy pattern 85 and the high-potential coil 23 is smaller than the distance between the dummy pattern 85 and the low-potential coil 22.

In that way, electric field concentration on the high-potential coil 23 can be suppressed properly. The smaller the distance between the dummy pattern 85 and the high-potential coil 23 with respect to the normal direction Z, the more effectively electric field concentration on the high-potential coil 23 can be suppressed. Preferably, the dummy pattern 85 is formed in the same interlayer insulation layer 57 as the high-potential coil 23. In that way, electric field concentration on the high-potential coil 23 can be suppressed more properly. The dummy pattern 85 includes a plurality of dummy patterns that are in varying electrical states. The dummy pattern 85 can include a high-potential dummy pattern.

The high-potential dummy pattern 86 can be formed at any depth in the insulation layer 51, which is adjusted according to the electric field strength to be attenuated. Preferably, the high-potential dummy pattern 86 is formed in a region closer to the high-potential coil 23 than to the low-potential coil 22 with respect to the normal direction Z. The high-potential dummy pattern 86 being closer to the high-potential coil 23 with respect to the normal direction Z means that, with respect to the normal direction Z, the distance between the high-potential dummy pattern 86 and the high-potential coil 23 is smaller than the distance between the high-potential dummy pattern 86 and the low-potential coil 22.

The dummy pattern 85 includes a floating dummy pattern that is formed in an electrically floating state in the insulation layer 51 so as to be located around the transformers 21A to 21D.

In the embodiment, the floating dummy pattern is patterned in dense lines so as to partly cover and partly expose a region around the high-potential coil 23 as seen in a plan view. The floating dummy pattern can be formed so as to have ends or no ends.

The floating dummy pattern can be formed at any depth in the insulation layer 51, which is adjusted according to the electric field strength to be attenuated.

Any number of floating lines can be provided, which is adjusted according to the electric field strength to be attenuated. The floating dummy pattern can include a plurality of floating dummy patterns.

Referring to FIG. 7, the semiconductor device 5 includes a second functional device 60 that is formed in the first principal surface 42 of the semiconductor chip 41 in a device region 62. The second functional device 60 is formed using a superficial part of the first principal surface 42 and/or a region on the first principal surface 42 of the semiconductor chip 41, and is covered by the insulation layer 51 (bottom insulation layer 55). In FIG. 7, the second functional device 60 is shown in a simplified form by broken lines indicated in a superficial part of the first principal surface 42.

The second functional device 60 is electrically connected to a low-potential terminal 11 via a low-potential wiring, and is electrically connected to a high-potential terminal 12 via a high-potential wiring. Except that the low-potential wiring is patterned in the insulation layer 51 so as to be connected to the second functional device 60, it has a similar structure to the first low-potential wiring 31 (second low-potential wiring 32). Except that the high-potential wiring is patterned in the insulation layer 51 so as to be connected to the second functional device 60, it has a similar structure to the first high-potential wiring 33 (second high-potential wiring 34). No description will be given of the low- and high-potential wirings associated with the second functional device 60.

The second functional device 60 can include at least one of a passive device, a semiconductor rectification device, and a semiconductor switching device. The second functional device 60 can include a circuit network comprising a selective combination of any two or more of a passive device, a semiconductor rectification device, and a semiconductor switching device. The circuit network can constitute part or the whole of an integrated circuit.

The passive device can include a semiconductor passive device. The passive device can include one or both of a resistor and a capacitor. The semiconductor rectification device can include at least one of a pn-junction diode, a PIN diode, a Zener diode, a Schottky barrier diode, and a fast-recovery diode. The semiconductor switching device can include at least one of a BJT (bipolar junction transistor), a MISFET (metal-insulator-semiconductor field-effect transistor), an IGBT (insulated-gate bipolar junction transistor), and a JFET (junction field-effect transistor).

Referring to FIGS. 5 to FIG. 7, the semiconductor device 5 further includes a sealing conductor 61 embedded in the insulation layer 51. The sealing conductor 61 is embedded in the form of walls in the insulation layer 51, at intervals from the insulation side walls 53A to 53D as seen in a plan view and partitions the insulation layer 51 into the device region 62 and an outer region 63. The sealing conductor 61 prevents moisture entry and crack development from the outer region 63 to the device region 62.

The device region 62 is a region that includes the first functional device 45 (plurality of transformers 21), the second functional device 60, the plurality of low-potential terminals 11, the plurality of high-potential terminals 12, the first low-potential wirings 31, the second low-potential wirings 32, the first high-potential wirings 33, the second high-potential wirings 34, and the dummy pattern 85. The outer region 63 is a region outside the device region 62.

The sealing conductor 61 is electrically isolated from the device region 62. Specifically, the sealing conductor 61 is electrically isolated from the first functional device 45 (plurality of transformers 21), the second functional device 60, the plurality of low-potential terminals 11, the plurality of high-potential terminals 12, the first low-potential wirings 31, the second low-potential wirings 32, the first high-potential wirings 33, the second high-potential wirings 34, and the dummy pattern 85. More specifically, the sealing conductor 61 is held in an electrically floating state. The sealing conductor 61 does not form a current path connected to the device region 62.

The sealing conductor 61 is formed in the shape of a stripe along the insulation side walls 53A to 53D as seen in a plan view. In the embodiment, the sealing conductor 61 is formed in a quadrangular ring shape (specifically, a rectangular ring shape) as seen in a plan view. Thus, the sealing conductor 61 defines the device region 62 in a quadrangular shape (specifically, a rectangular shape) as seen in a plan view. Furthermore, the sealing conductor 61 defines the outer region 63 in a quadrangular ring shape (specifically, a rectangular ring shape) surrounding the device region 62 as seen in a plan view.

Specifically, the sealing conductor 61 has a top end part at the insulation principal surface 52 side, a bottom end part at the semiconductor chip 41 side, and a wall part that extends in the form of walls between the top and bottom end parts. In the embodiment, the top end part of the sealing conductor 61 is formed at an interval from the insulation principal surface 52 toward the semiconductor chip 41 and is located in the insulation layer 51. In the embodiment, the top end part of the sealing conductor 61 is covered by the top insulation layer 56. The top end part of the sealing conductor 61 can be covered by one or a plurality of interlayer insulation layers 57. The top end part of the sealing conductor 61 can be exposed through the top insulation layer 56. The bottom end part of the scaling conductor 61 is formed at an interval from the semiconductor chip 41 toward the top end part.

Thus, in the embodiment, the sealing conductor 61 is embedded in the insulation layer 51 so as to be located at the semiconductor chip 41 side of the plurality of low-potential terminals 11 and the plurality of high-potential terminals 12. Moreover, in the insulation layer 51, the sealing conductor 61 faces, in the direction parallel to the insulation principal surface 52, the first functional device 45 (plurality of transformers 21), the first low-potential wirings 31, the second low-potential wirings 32, the first high-potential wirings 33, the second high-potential wirings 34, and the dummy pattern 85. In the insulation layer 51, the sealing conductor 61 can face, in the direction parallel to the insulation principal surface 52, part of the second functional device 60.

The sealing conductor 61 includes a plurality of scaling plug conductors 64 and one or a plurality of (in the embodiment, a plurality of) sealing via conductors 65. Any number of scaling via conductors 65 may be provided. Of the plurality of sealing plug conductors 64, the top scaling plug conductor 64 constitutes the top end part of the sealing conductor 61. The plurality of sealing via conductors 65 constitute the bottom end part of the scaling conductor 61. Preferably, the sealing plug conductors 64 and the sealing via conductors 65 are formed of the same conductive material as the low-potential coil 22. That is, preferably, like the low-potential coil 22 and the like, the sealing plug conductors 64 and the sealing via conductors 65 each include a barrier layer and a body layer.

The plurality of sealing plug conductors 64 are embedded in the plurality of interlayer insulation layers 57 respectively, and are each formed in a quadrangular ring shape (specifically, a rectangular ring shape) surrounding the device region 62 as seen in a plan view. The plurality of scaling plug conductors 64 are stacked together from the bottom insulation layer 55 to the top insulation layer 56 so as to be connected together. The number of layers stacked in the plurality of sealing plug conductors 64 is equal to the number of layers in the plurality of interlayer insulation layers 57. Needless to say, one or a plurality of sealing plug conductors 64 may be formed that penetrates a plurality of interlayer insulation layers 57.

So long as a set of a plurality of sealing plug conductors 64 constitutes one ring-shaped scaling conductor 61, not all the sealing plug conductors 64 need be formed in a ring shape. For example, at least one of the plurality of sealing plug conductors 64 can be formed so as to have ends. Or at least one of the plurality of sealing plug conductors 64 may be divided into a plurality of strip-shaped portions with ends. However, with consideration given to the risk of moisture entry and crack development into the device region 62, preferably, the plurality of sealing plug conductors 64 are formed so as to have no ends (in a ring shape).

The plurality of sealing via conductors 65 are formed in the bottom insulation layer 55, in a region between the semiconductor chip 41 and the sealing plug conductors 64. The plurality of sealing via conductors 65 are formed at an interval from the semiconductor chip 41 and are connected to the sealing plug conductors 64. The plurality of scaling via conductors 65 have a plane area smaller than the plane area of the sealing plug conductors 64. In a case where a single sealing via conductor 65 is formed, the single scaling via conductors 65 can have a plane area equal to or larger than the plane area of the scaling plug conductors 64.

The sealing conductor 61 can have a width of 0.1 μm or more but 10 μm or less. Preferably, the sealing conductor 61 has a width of 1 μm or more but 5 μm or less. The width of the sealing conductor 61 is defined by its width in the direction orthogonal to the direction in which it extends.

Referring to FIG. 7 and FIG. 8, the semiconductor device 5 further includes the separation structure 130 that is interposed between the semiconductor chip 41 and the sealing conductor 61 and that electrically isolates the sealing conductor 61 from the semiconductor chip 41. Preferably, the separation structure 130 includes an insulator. In the embodiment, the separation structure 130 is a field insulation film 131 formed on the first principal surface 42 of the semiconductor chip 41.

The field insulation film 131 includes at least one of an oxide film (silicon oxide film) and a nitride film (silicon nitride film). Preferably, the field insulation film 131 is a LOCOS (local oxidation of silicon) film as one example of an oxide film that is formed through oxidation of the first principal surface 42 of the semiconductor chip 41. The field insulation film 131 can have any thickness so long as it can insulate between the semiconductor chip 41 and the sealing conductor 61. The field insulation film 131 can have a thickness of 0.1 μm or more but 5 μm or less.

The separation structure 130 is formed on the first principal surface 42 of the semiconductor chip 41, and extends in the shape of a stripe along the sealing conductor 61 as seen in a plan view. In the embodiment, the separation structure 130 is formed in a quadrangular ring shape (specifically, a rectangular ring shape) as seen in a plan view. The separation structure 130 has a connection portion 132 to which the bottom end part of the scaling conductor 61 (i.e., the sealing via conductors 65) is connected. The connection portion 132 can form an anchor portion into which the bottom end part of the sealing conductor 61 (i.e., the sealing via conductors 65) is anchored toward the semiconductor chip 41. Needless to say, the connection portion 132 can be formed to be flush with the principal surface of the separation structure 130.

The separation structure 130 includes an inner end part 130A at the device region 62 side, an outer end part 130B at the outer region 63 side, and a main body part 130C between the inner and outer end parts 130A and 130B. As seen in a plan view, the inner end part 130A defines the region where the second functional device 60 is formed (i.e., the device region 62). The inner end part 130A can be formed integrally with an insulation film (not illustrated) formed on the first principal surface 42 of the semiconductor chip 41.

The outer end part 130B is exposed on the chip side walls 44A to 44D of the semiconductor chip 41, and is continuous with the chip side walls 44A to 44D of the semiconductor chip 41. More specifically, the outer end part 130B is formed so as to be flush with the chip side walls 44A to 44D of the semiconductor chip 41. The outer end part 130B constitutes a polished surface between, to be flush with, the chip side walls 44A to 44D of the semiconductor chip 41 and the insulation side walls 53A to 53D of the insulation layer 51. Needless to say, an embodiment is also possible where the outer end part 130B is formed within the first principal surface 42 at intervals from the chip side walls 44A to 44D.

The main body part 130C has a flat surface that extends substantially parallel to the first principal surface 42 of the semiconductor chip 41. The main body part 130C has the connection portion 132 to which the bottom end part of the sealing conductor 61 (i.e., the sealing via conductors 65) is connected. The connection portion 132 is formed in the main body part 130C, at intervals from the inner and outer end parts 130A and 130B. The separation structure 130 can be implemented in many ways other than in the form of a field insulation film 131.

Referring to FIG. 7, the semiconductor device 5 further includes an inorganic insulation layer 140 formed on the insulation principal surface 52 of the insulation layer 51 so as to cover the sealing conductor 61. The inorganic insulation layer 140 can be called a passivation layer. The inorganic insulation layer 140 protects the insulation layer 51 and the semiconductor chip 41 from above the insulation principal surface 52.

In the embodiment, the inorganic insulation layer 140 has a stacked structure composed of a first inorganic insulation layer 141 and a second inorganic insulation layer 142. The first inorganic insulation layer 141 can contain silicon oxide. Preferably, the first inorganic insulation layer 141 contains USG (undoped silicate glass), which is undoped silicon oxide.

The first inorganic insulation layer 141 can have a thickness of 50 nm or more but 5000 nm or less. The second inorganic insulation layer 142 can contain silicon nitride. The second inorganic insulation layer 142 can have a thickness of 500 nm or more but 5000 nm or less. Increasing the total thickness of the inorganic insulation layer 140 helps increase the dielectric strength voltage above the high-potential coils 23.

In a configuration where the first inorganic insulation layer 141 is made of USG and the second inorganic insulation layer 142 is made of silicon nitride, USG has the higher dielectric breakdown voltage (V/cm) than silicon nitride. In view of this, when thickening the inorganic insulation layer 140, it is preferable to form the first inorganic insulation layer 141 thicker than the second inorganic insulation layer 142.

The first inorganic insulation layer 141 can contain at least one of BPSG (boron-doped phosphor silicate glass) and PSG (phosphorus silicate glass) as examples of silicon oxide. In that case, however, since the silicon oxide contains a dopant (boron or phosphorus), for an increased dielectric strength voltage above the high-potential coils 23, it is particularly preferable to form the first inorganic insulation layer 141 of USG. Needless to say, the inorganic insulation layer 140 can have a single-layer structure composed of either the first or second inorganic insulation layer 141 or 142.

The inorganic insulation layer 140 covers the entire area of the sealing conductor 61, and has a plurality of low-potential pad openings 143 and a plurality of high-potential pad openings 144 that are formed in a region outside the sealing conductor 61. The plurality of low-potential pad openings 143 expose the plurality of low-potential terminals 11 respectively. The plurality of high-potential pad openings 144 expose the plurality of high-potential terminals 12 respectively. The inorganic insulation layer 140 can have overlap parts that overlap circumferential edge parts of the low-potential terminals 11. The inorganic insulation layer 140 can have overlap parts that overlap circumferential edge parts of the high-potential terminals 12.

The semiconductor device 5 further includes an organic insulation layer 145 that is formed on the inorganic insulation layer 140. The organic insulation layer 145 can contain photosensitive resin. The organic insulation layer 145 can contain at least one of polyimide, polyamide, and polybenzoxazole. In the embodiment, the organic insulation layer 145 contains polyimide. The organic insulation layer 145 can have a thickness of 1 μm or more but 50 μm or less.

Preferably, the organic insulation layer 145 has a thickness larger than the total thickness of the inorganic insulation layer 140. Moreover, preferably, the inorganic and organic insulation layers 140 and 145 together have a total thickness larger than the distance D2 between the low- and high-potential coils 22 and 23. In that case, preferably, the inorganic insulation layer 140 has a total thickness of 2 μm or more but 10 μm or less. Preferably, the organic insulation layer 145 has a thickness of 5 μm or more but 50 μm or less. Such structures help suppress an increase in the thicknesses of the inorganic and organic insulation layers 140 and 145 while appropriately increasing the dielectric strength voltage above the high-potential coil 23 owing to the stacked film of the inorganic and organic insulation layers 140 and 145.

The organic insulation layer 145 includes a first part 146 that covers a low-potential side region and a second part 147 that covers a high-potential side region. The first part 146 covers the sealing conductor 61 across the inorganic insulation layer 140. The first part 146 has a plurality of low-potential terminal openings 148 through which the plurality of low-potential terminals 11 (low-potential pad openings 143) are respectively exposed in a region outside the sealing conductor 61. The first part 146 can have overlap parts that overlap circumferential edges (overlap parts) of the low-potential pad openings 143.

The second part 147 is formed at an interval from the first part 146, and exposes the inorganic insulation layer 140 between the first and second parts 146 and 147. The second part 147 has a plurality of high-potential terminal openings 149 through which the plurality of high-potential terminals 12 (high-potential pad openings 144) are respectively exposed. The second part 147 can have overlap parts that overlap circumferential edges (overlap parts) of the high-potential pad openings 144.

The second part 147 covers the transformers 21A to 21D and the dummy pattern 85 together. Specifically, the second part 147 covers the plurality of high-potential coils 23, the plurality of high-potential terminals 12, a first high-potential dummy pattern 87, a second high-potential dummy pattern 88, and a floating dummy pattern 121 together.

The present disclosure can be implemented in any other embodiments. The embodiment described above deals with an example where a first functional device 45 and a second functional device 60 are formed. An embodiment is however also possible that only has a second functional device 60, with no first functional device 45. In that case, the dummy pattern 85 may be omitted. This structure provides, with respect to the second functional device 60, effects similar to those mentioned in connection with the first embodiment (except those associated with the dummy pattern 85).

That is, in a case where a voltage is applied to the second functional device 60 via the low- and high-potential terminals 11 and 12, it is possible to suppress unnecessary conduction between the high-potential terminal 12 and the sealing conductor 61. Likewise, in a case where a voltage is applied to the second functional device 60 via the low- and high-potential terminals 11 and 12, it is possible to suppress unnecessary conduction between the low-potential terminal 11 and the sealing conductor 61.

The embodiment described above deals with an example where a second functional device 60 is formed. The second functional device 60 however is not essential, and can be omitted.

The embodiment described above deals with an example where a dummy pattern 85 is formed. The dummy pattern 85 however is not essential, and can be omitted.

The embodiment described above deals with an example where the first functional device 45 is of a multichannel type that includes a plurality of transformers 21. It is however also possible to employ a single-channel first functional device 45 that includes a single transformer 21.

### Transformer Layout

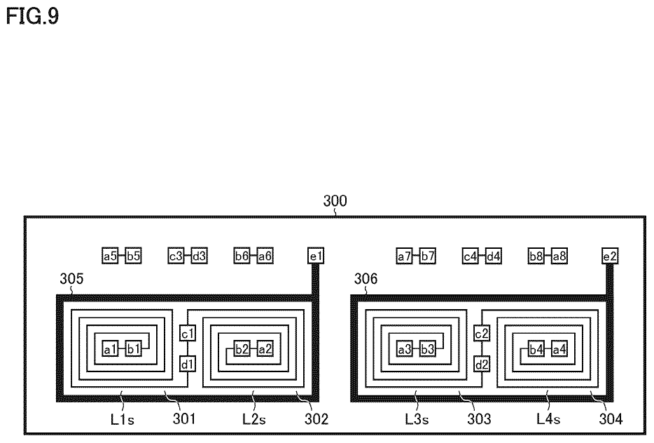

FIG. 9 is a plan view (top view) schematically showing one example of transformer layout in a two-channel transformer chip 300 (corresponding to the semiconductor device 5 described previously). The transformer chip 300 shown there includes a first transformer 301, a second transformer 302, a third transformer 303, a fourth transformer 304, a first guard ring 305, a second guard ring 306, pads a1 to a8, pads b1 to b8, pads c1 to c4, and pads d1 to d4.

In the transformer chip 300, the pads a1 and b1 are connected to one terminal of the secondary coil L1s of the first transformer 301, and the pads c1 and d1 are connected to the other terminal of that secondary coil L1s. The pads a2 and b2 are connected to one terminal of the secondary coil L2s of the second transformer 302, and the pads c1 and d1 are connected to the other terminal of that secondary coil L2s.

Moreover, the pads a3 and b3 are connected to one terminal of the secondary coil L3s of the third transformer 303, and the pads c2 and d2 are connected to the other terminal of that secondary coil L3s. The pads a4 and b4 are connected to one terminal of the secondary coil L4s of the fourth transformer 304, and the pads c2 and d2 are connected to the other terminal of that secondary coil L4s.

FIG. 9 does not show any of the primary coils of the first, second, third, and fourth transformers 301, 302, 303, and 304. The primary coils basically have structures similar to those of the secondary coils L1s to Ls respectively, and are disposed right below the secondary coils L1s to L4s, respectively, so as to face them.

Specifically, the pads a5 and b5 are connected to one terminal of the primary coil of the first transformer 301, and the pads c3 and d3 are connected to the other terminal of that primary coil. Likewise, the pads a6 and b6 are connected to one terminal of the primary coil of the second transformer 302, and the pads c3 and d3 are connected to the other terminal of that primary coil.

Likewise, the pads a7 and b7 are connected to one terminal of the primary coil of the third transformer 303, and the pads c4 and d4 are connected to the other terminal of that primary coil. Likewise, the pads a8 and b8 are connected to one terminal of the primary coil of the fourth transformer 304, and the pads c4 and d4 are connected to the other terminal of that primary coil.

The pads a5 to a8, the pads b5 to b8, the pads c3 and c4, and the pads d3 and d4 mentioned above are each led from inside the transformer chip 300 to its surface across an unillustrated via.

Of the plurality of pads mentioned above, the pads a1 to a8 each correspond to a first current feed pad, and the pads b1 to b8 each correspond to a first voltage measurement pad; the pads c1 to c4 each correspond to a second current feed pad, and the pads d1 to d4 each correspond to a second voltage measurement pad.

Thus, the transformer chip 300 of this configuration example permits, during its defect inspection, accurate measurement of the series resistance component across each coil. It is thus possible not only to reject defective products with a broken wire in a coil but also to appropriately reject defective products with an abnormal resistance value in a coil (e.g., a midway short circuit between coils), and hence to prevent defective products from being distributed in the market.

For a transformer chip 300 that has passed the defect inspection mentioned above, the plurality of pads described above can be used for connection with a primary-side chip and a secondary-side chip (e.g., the controller chip 210 and the driver chip 220 described previously).

Specifically, the pads a1 and b1, the pads a2 and b2, the pads a3 and b3, and the pads a4 and b4 can each be connected to one of the signal input and output terminals of the secondary-side chip; the pads c1 and d1 and the pads c2 and d2 can each be connected to a common voltage application terminal (GND2) of the secondary-side chip.

On the other hand, the pads a5 and b5, the pads a6 and b6, the pads a7 and b7, and the pads a8 and b8 can each be connected to one of the signal input and output terminals of the primary-side chip; the pads c3 and d3 and the pads c4 and d4 can each be connected to a common voltage application terminal (GND1) of the primary-side chip.

Here, as shown in FIG. 9, the first to fourth transformers 301 to 304 are so arranged as to be coupled for each signal transmission direction. In terms of what is shown in the diagram, for example, the first and second transformers 301 and 302, which transmit a signal from the primary-side chip to the secondary-side chip, are coupled into a first pair by the first guard ring 305. Likewise, for example, the third and fourth transformers 303 and 304, which transmit a signal from the secondary-side chip to the primary-side chip, are coupled into a second pair by the second guard ring 306.

Such coupling is intended, in a structure where the primary and secondary coils of each of the first to fourth transformers 301 to 304 are formed so as to be stacked on each other in the up-down direction of the substrate of the transformer chip 300, to obtain a desired withstand voltage between the primary and secondary coils. The first and second guard rings 305 and 306 are, however, not essential elements.

The first and second guard rings 305 and 306 can be connected via pads c1 and c2, respectively, to a low-impedance wiring such as a grounded terminal.

In the transformer chip 300, the pads c1 and d1 are shared between the secondary coils L1s and L2s. The pads c2 and d2 are shared between the secondary coils L3s and L4s. The pads c3 and d3 are shared between the primary coils L1p and L2p. The pads c4 and d4 are shared between the primary coils that correspond to them respectively. This configuration helps reduce the number of pads and helps make the transformer chip 300 compact.

Moreover, as shown in FIG. 9, the primary and secondary coils of the first to fourth transformers 301 to 304 are preferably each wound in a rectangular shape (or, with the corners rounded, in a running-track shape) as seen in a plan view of the transformer chip 300. This configuration helps increase the area over which the primary and secondary coils overlap each other and helps enhance the transmission efficiency across the transformers.

Needless to say, the illustrated transformer layout is merely an example; any number of coils of any shape can be disposed in any layout, and pads can be disposed in any layout. Any of the chip structure, transformer layouts, etc. described above can be applied to semiconductor devices in general that have a coil integrated in a semiconductor chip.

### Signal Transmission Device (First Embodiment)

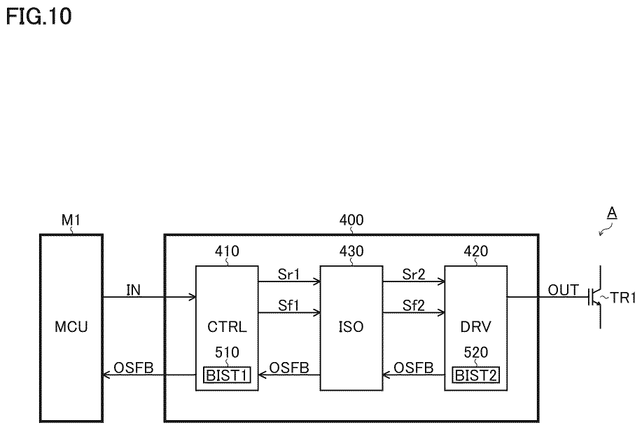

FIG. 10 is a diagram showing a signal transmission device of a first embodiment. The signal transmission device 400 according to the embodiment is incorporated together with a microcontroller M1 and a switching device TR1 in an electronic device A.

The switching device TR1 can be, for example, a high-side or low-side switching device in a half-bridge or full-bridge output stage. A half-bridge or full-bridge output stage can be used as a load driving means such as a motor driver, or as a power conversion means such as an inverter. As shown in the diagram, the switching device TR1 can be an IGBT. Or, the switching device TR1 can be replaced with a MOSFET (metal-oxide-semiconductor field-effect transistor) or the like.

The signal transmission device 400 drives the switching device TR1 by generating an output pulse signal OUT according to an input pulse signal IN output from the microcontroller M1 while isolating between the microcontroller M1 and the switching device TR1. That is, the signal transmission device 400 can be understood to be a semiconductor integrated circuit device generally called an insulated gate driver IC.

In terms of what is shown in the diagram, like the signal transmission device 200 described previously (FIG. 1), the signal transmission device 400 can have, sealed in a single package, a controller chip 410 (corresponding to a first chip) that generates transmission pulse signals Sr1 and Sf1 from the input pulse signal IN, a driver chip 420 (corresponding to a second chip) that generates the output pulse signal OUT from reception pulse signals Sr2 and Sf2, and a transformer chip 430 (corresponding to a third chip) that transmits the transmission pulse signals Sr1 and Sf1 as the reception pulse signals Sr2 and Sf2 while isolating between the controller chip 410 and the driver chip 420.

The transmission pulse signals Sr1 and Sf1 can be understood to be the transmission pulse signals S11 and S21 described previously, respectively. On the other hand, the reception pulse signals Sr2 and Sf2 can be understood to be the reception pulse signals S12 and S22 described previously, respectively.

Note that the driver chip 420 can be understood to be a semiconductor chip that has a driving circuit integrated in it for driving the switching device TR1 by generating the output pulse signal OUT according to the input pulse signal IN through isolated communication with the controller chip 410.

The signal transmission device 400 also has a function of outputting to the microcontroller M1 a switching-state signal OSFB according to the on/off state of the switching device TR1. For example, the switching-state signal OSFB can be transmitted to the microcontroller M1 from the driver chip 420 via the transformer chip 430 and the controller chip 410. That is, the driver chip 420 can have a function of generating the switching-state signal OSFB according to the logic level of the output pulse signal OUT to provide feedback for the controller chip 410.

The microcontroller M1 can, by monitoring the switching-state signal OSFB, check whether the switching device TR1 is turned on and off in response to the input pulse signal IN as intended.

The controller chip 410 also has a function, in case of inconsistency between the logic levels of the input pulse signal IN and the output pulse signal OUT (hence the switching-state signal OSFB), of appropriately generating the transmission pulse signals Sr1 and Sf1 and once again notifying the driver chip 420 of the logic level of the input pulse signal IN.

For example, consider a case where, although the input pulse signal IN is at high level, the switching-state signal OSFB is at low level (the logic level indicating that the output pulse signal OUT is at low level). In that case, the controller chip 410 itself generates the transmission pulse signal Sr1 (a signal for notifying that the input pulse signal IN is at high level) in order to turn the output pulse signal OUT to high level.

For another example, consider a case where, although the input pulse signal IN is at low level, the switching-state signal OSFB is at high level (the logic level indicating that the output pulse signal OUT is at high level). In that case, the controller chip 410 itself generates the transmission pulse signal Sf1 (a signal notifying that the input pulse signal IN is at low level) to turn the output pulse signal OUT to low level.

The signal transmission device 400 also has a self-diagnosis function for checking whether individual parts are operating properly. In terms of what is shown in the diagram, the controller chip 410 includes a self-diagnosis circuit 510 for checking whether individual parts of the controller chip 410 are operating properly. On the other hand, the driver chip 420 includes a self-diagnosis circuit 520 for checking whether individual parts of the driver chip 420 are operating properly. The self-diagnosis circuit 520 can start self-diagnosis operation in response to a self-diagnosis instruction (which will be described in detail later) transmitted from the controller chip 410.

### Driver Chip (Self-Diagnosis Circuit)

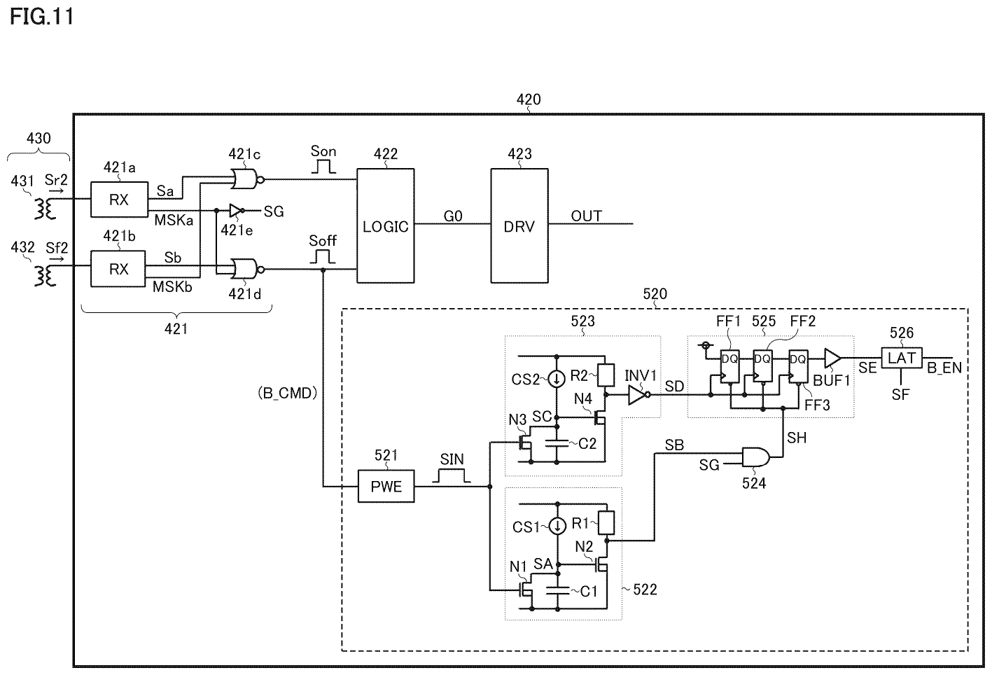

FIG. 11 is a diagram showing one configuration example of the driver chip 420 (in particular, the self-diagnosis circuit 520). The diagram depicts transformers 431 and 432 integrated in the transformer chip 430 as an isolated communication means for the reception pulse signals Sr2 and Sf2 respectively.

The controller chip 410, not shown, notifies the driver chip 420 via the transformer 431 (corresponding to a first isolating device) that the input pulse signal IN is at high level (the logic level to turn on the switching device TR1). The controller chip 410 also notifies the driver chip 420 via the transformer 432 (corresponding to a second isolating device) that the input pulse signal IN is at low level (the logic level to turn off the switching device TR1).

The driver chip 420 of this configuration example includes, in addition to the self-diagnosis circuit 520 described previously, a pulse reception circuit 421, a logic circuit 422, and a driver 423.

The pulse reception circuit 421 receives the reception pulse signals Sr2 and Sf2 and generates an on-signal Son and an off-signal Soff. In terms of what is shown in the diagram, the pulse reception circuit 421 includes receivers 421a and 421b, NOR gates 421c and 421d, and an inverter 421e.

The receiver 421a generates a reception pulse signal Sa and a mask signal MSKa from the reception pulse signal Sr2. The mask signal MSKa can be generated, for example, so as to have a larger pulse width than the reception pulse signal Sa.

The receiver 421b generates a reception pulse signal Sb and a mask signal MSKb from the reception pulse signal Sf2. The mask signal MSKb can be generated, for example, so as to have a larger pulse width than the reception pulse signal Sb.

The NOR gate 421c generates the on-signal Son through a NOR operation between the reception pulse signal Sa and the mask signal MSKb. Note that the on-signal Son is at low level when at least one of the reception pulse signal Sa and the mask signal MSKb is at high level. On the other hand, the on-signal Son is at high level when the reception pulse signal Sa and the mask signal MSKb are both at low level.

The NOR gate 421d generates the off-signal Soff through a NOR operation between the reception pulse signal Sb and the mask signal MSKa. Note that the off-signal Soff is at low level when at least one of the reception pulse signal Sb and the mask signal MSKa is at high level. On the other hand, the off-signal Soff is at high level when the reception pulse signal Sb and the mask signal MSKa are both at low level.

Note that the NOR gates 421c and 421d function as a noise canceller for removing common-mode noise induced in each of the reception pulse signals Sa and Sb.

The inverter 421e generates an internal signal SG by inverting the logic level of the mask signal a. Thus, the internal signal SG is at low level when the mask signal MSKa is at high level. On the other hand, the internal signal SG is at high level when the mask signal MSKa is at low level.

The logic circuit 422 generates a driver driving signal G0 according to the on-signal Son and the off-signal Soff. For example, in response to the on-signal Son being pulse-driven, the logic circuit 422 turns the driver driving signal G0 to low level (the logic level to turn on the switching device TR1). On the other hand, in response to the off-signal Soff being pulse-driven, the logic circuit 422 turns the driver driving signal G0 to high level (the logic level to turn off the switching device TR1). Note that the logic circuit 422 can include, for example, an RS flip-flop.

The driver 423 generates the output pulse signal OUT according to the driver driving signal G0. For example, the driver 423 turns the output pulse signal OUT to high level when the driver driving signal G0 is at high level. On the other hand, the driver 423 turns the output pulse signal OUT to low level when the driver driving signal G0 is at low level.

The self-diagnosis circuit 520 shares the transformer 432 (a transformer for transmitting the off-signal Soff) as a means for transmitting a self-diagnosis instruction B_CMD (a trigger to start the operation of the self-diagnosis circuit 520) from the controller chip 410 to the driver chip 420.

Employing such a configuration eliminates the need for a dedicated signal transmission path (separate transformer) and thus allows size reduction of the transformer chip 430 (hence the entire signal transmission device 400).

In the case where the transformer 432 is shared, the driver chip 420 needs to be able to judge whether the reception pulse signal Sf2 transmitted via the transformer 432 is a gate-off instruction for the switching device TR1 or the self-diagnosis instruction B_CMD. Thus, the controller chip 410 drives the transformer 432 at a different pulse period than in ordinary operation (when transmitting the gate-off instruction) to transmit the self-diagnosis instruction B_CMD.

For example, when transmitting the normal gate-off instruction via the transformer 432, the controller chip 410 generates one or more (e.g., seven) pulses at 10 MHz (pulse period T0=0.1 μs) in the transmission pulse signal Sf1 (hence in the reception pulse signal Sf2 transmitted via the transformer 432) by being triggered by a falling edge in the input pulse signal IN.

On the other hand, when transmitting the self-diagnosis instruction B_CMD via the transformer 432, the controller chip 410 periodically generates a pulse at 1 MHz (pulse period T1=1 μs) in the transmission pulse signal Sf1 (hence in the reception pulse signal Sf2 transmitted via the transformer 432). Note that the periodic pulse generated during the transmission of the self-diagnosis instruction B_CMD can be a single pulse at a time or a series of pulses (e.g., a group of a plurality of pulses generated at 10 MHz).

With such pulse driving, the driver chip 420 can judge whether the reception pulse signal Sf2 transmitted via the transformer 432 is the gate-off instruction for the switching device TR1 or the self-diagnosis instruction B_CMD.

In terms of what is shown in the diagram, the self-diagnosis circuit 520 includes a pulse-width extender circuit 521, a signal interval judgment circuits 522 and 523, an AND gate 524, a counter 525, and a latch 526.

The pulse-width extender circuit 521 extends the pulse width of the off-signal Soff to generate an internal signal SIN.

The signal interval judgment circuit 522 generates an internal signal SB for checking whether the signal interval T2 between pulse groups generated in the off-signal Soff at a predetermined pulse period T1 (i.e., the period for which the off-signal Soff is kept at low level without being pulse-driven) is shorter than a predetermined upper limit time TH. Note that the upper limit time TH can be set at, for example, 2.3 μs.

In terms of what is shown in the diagram, the signal interval judgment circuit 522 includes a capacitor C1, a current source CS1, transistors N1 and N2 (e.g., NMOSFETs), and a resistor R1.

The gate of the transistor N1 is connected to an application terminal for the internal signal SIN. The first terminals of the current source CS1 and the resistor R1 are both connected to a first potential terminal (e.g., an internal power source terminal). The second terminal of the current source CS1, the first terminal of the capacitor C1, the drain of the transistor N1, and the gate of the transistor N2 are all connected to an application terminal for an internal signal SA. The second terminal of the resistor R1 and the drain of the transistor N2 are both connected to an application terminal for the internal signal SB. The second terminal of the capacitor C1 and the sources of the transistors N1 and N2 are all connected to a second potential terminal (e.g., a ground terminal).

When the internal signal SIN rises to high level, the transistor N1 is turned on. This discharges the capacitor C1 to turn the internal signal SA to low level. Thus, the transistor N2 is turned off. As a result, the internal signal SB is turned to high level.

Then, when the internal signal SIN falls to low level, the transistor N1 is turned off. Thus, as the capacitor C1 is charged, the internal signal SA rises. If the upper limit time TH elapses with no subsequent pulse generated in the internal signal SIN, the internal signal SA reaches an on-threshold Vth (N2) of the transistor N2. As a result, the transistor N2 is turned on and the internal signal SB is turned to low level.

That is, the internal signal SB is kept at high level if T2<TH and is turned to low level if T2>TH.

The signal interval judgment circuit 523 generates an internal signal SD for checking whether the signal interval T2 between pulse groups generated in the off-signal Soff at the predetermined pulse period T1 is longer than a predetermined lower limit time TL. Note that the lower limit time TL can be set at, for example, 0.45 μs.

In terms of what is shown in the diagram, the signal interval judgment circuit 523 includes a capacitor C2, a current source CS2, transistors N3 and N4 (e.g., NMOSFETs), a resistor R2, and an inverter INV1.

The gate of the transistor N3 is connected to an application terminal for the internal signal SIN. The first terminals of the current source CS2 and the resistor R2 are both connected to a first potential terminal (e.g., an internal power source terminal). The second terminal of the current source CS2, the first terminal of the capacitor C2, the drain of the transistor N3, and the gate of the transistor N4 are all connected to an application terminal for an internal signal SC. The second terminal of the resistor R2 and the drain of the transistor N4 are both connected to the input terminal of the inverter INV1. The output terminal of the inverter INV1 is connected to an application terminal for the internal signal SD. The second terminal of the capacitor C2 and the sources of the transistors N3 and N4 are all connected to a second potential terminal (e.g., a ground terminal).

When the internal signal SIN rises to high level, the transistor N3 is turned on. This discharges the capacitor C2 to turn the internal signal SC to low level. Thus, the transistor N4 is turned off. As a result, the internal signal SD is turned to low level.

Then, when the internal signal SIN falls to low level, the transistor N3 is turned off. Thus, as the capacitor C2 is charged, the internal signal SC rises. If the lower limit time TL elapses with no subsequent pulse generated in the internal signal SIN, the internal signal SC reaches an on-threshold Vth (N4) of the transistor N4. As a result, the transistor N4 is turned on and the internal signal SD is turned to high level.

That is, the internal signal SD is kept at low level if T2<TL and is turned to high level if T2>TL. In other words, when T2>TL, the internal signal SD is pulse-driven at a pulse period T1.

The AND gate 524 generates an internal signal SH by performing an AND operation between the internal signals SB and SG. Note that the internal signal SH is at low level when at least one of the internal signals SB and SG is at low level. On the other hand, the internal signal SH is at high level when the internal signals SB and SG are both at high level. That is, the internal signal SH is at low level when the signal interval T2 in the off-signal Soff is longer than the upper limit time TH or when a pulse is generated in the mask signal MSKa (hence in the reception pulse signal Sr2 corresponding to a gate-on instruction).

The counter 525 generates an internal signal SE by counting the number of pulses in the internal signal SD. In terms of what is shown in the diagram, the counter 525 includes D flip-flops FF1 to FF3 and a buffer BUF1.

The clock terminals (>) of the D flip-flops FF1 to FF3 are all connected to an application terminal for the internal signal SD. The reset terminals (O) of the D flip-flops FF1 to FF3 are all connected to an application terminal for the internal signal SH. The data terminal (D) of the D flip-flop FF1 is connected to an application terminal for high level voltage (e.g., an internal power source terminal). The output terminal (Q) of the D flip-flop FF1 is connected to the data terminal (D) of the D flip-flop FF2. The output terminal (Q) of the D flip-flop FF2 is connected to the data terminal (D) of the D flip-flop FF3. The output terminal (Q) of the D flip-flop FF3 is connected to the input terminal of the buffer BUF1. The output terminal of the buffer BUF1 is connected to an application terminal for the internal signal SE.

For example, the counter 525 turns the internal signal SE to high level when the number of pulses in the internal signal SD reaches a predetermined threshold value (three in the diagram). Note that the count value of the counter 525 (the number of pulses in the internal signal SD) is reset to a zero value when the internal signal SH is turned to low level.

The latch 526 receives the internal signal SE and generates a self-diagnosis enable signal B_EN. More specifically, the latch 526 keeps the self-diagnosis enable signal B_EN at high level (the logic level corresponding to an enabled state) for a predetermined period from a rise of the internal signal SF. After the lapse of the predetermined period, the latch 526 turns the self-diagnosis enable signal B_EN back to low level (the logic level corresponding to a disabled state) at a fall of the internal signal SF. Such a configuration eliminates the need to receive a self-diagnosis cancel instruction from the controller chip 410.

In the self-diagnosis circuit 520 of this configuration example, if the signal interval T2 between pulse groups generated in the off-signal Soff at the pulse period T1 is within a predetermined range (TL<T2<TH) and in addition if the pulse groups are detected consecutively over a plurality of periods (e.g., three periods or more), the reception pulse signal Sf2 (hence the off-signal Soff) is judged to be the self-diagnosis instruction B_CMD. As a result, the self-diagnosis enable signal B_EN rises to high level.

When the self-diagnosis instruction B_CMD is transmitted, as when the gate-off instruction is transmitted, the reception pulse signal Sf2 is pulse-driven. Thus, the logic circuit 422 and the driver 423 turn the output pulse signal OUT to low level. This prevents the switching device TR1 from being erroneously turned on during the self-diagnosis of the signal transmission device 400.

A method that distinguishes between the gate-off instruction and the self-diagnosis instruction based on a difference in the pulse period is less likely to make an erroneous judgment than a method that distinguishes between those instructions based on a difference in the number of pulses.

### Study on Appearance of Unintended Self-Diagnosis Instruction

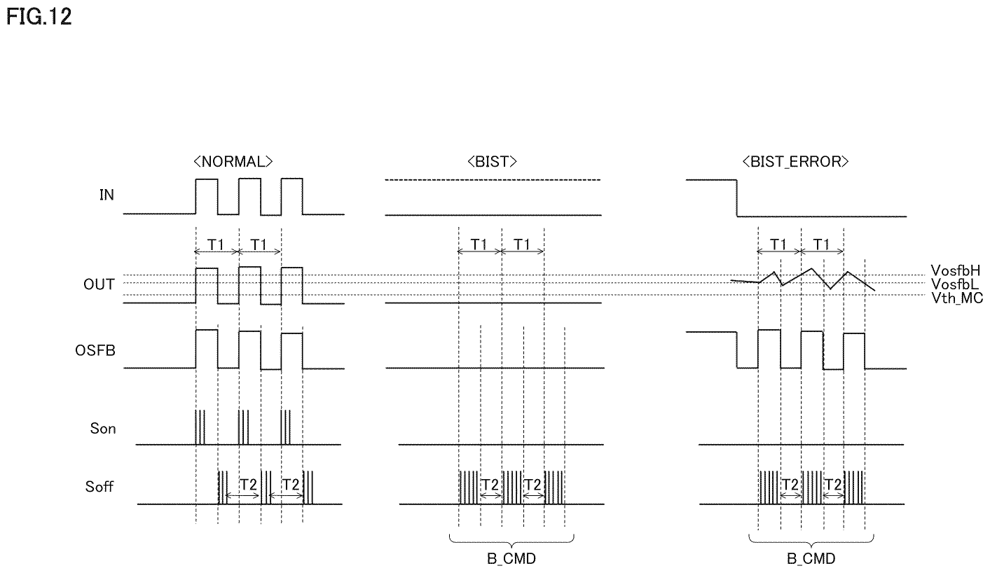

FIG. 12 is a diagram showing how an unintended self-diagnosis instruction B_CMD appears in the off-signal Soff. The diagram depicts, in a left, a middle, and a right region of it, from top down, the input pulse signal IN, the output pulse signal OUT, the switching-state signal OSFB, the on-signal Son, and the off-signal Soff. For convenience's sake, no delay time of the switching-state signal OSFB is illustrated.

First, with reference to the left region of the diagram, the behavior (indicated as “NORMAL” in the diagram) in the normal state, that is, during the transmission of the gate-on instruction and the gate-off instruction, will be described.

As shown in the diagram, the input pulse signal IN can be pulse-driven at a pulse period T1 (e.g., 1 μs). In this case, the on-signal Son and the off-signal Soff are pulse-driven at the pulse period T1 by being triggered by the rising and falling edges, respectively, in the input pulse signal IN. Thus, also the output pulse signal OUT (hence the switching-state signal OSFB) is pulse-driven at the pulse period T1.

Meanwhile, the signal interval T2 between pulse groups generated in the off-signal Soff at the pulse period T1 can satisfy the judgment condition (TL<T2<TH) for the self-diagnosis instruction B_CMD. The counter 525 (see FIG. 11) described previously, however, is reset when a pulse is generated in the on-signal Son. Thus, the off-signal Soff is not erroneously judged to be the self-diagnosis instruction B_CMD.

Next, with reference to the middle region of the diagram, the behavior (indicated as “BIST” in the diagram) during the transmission of the self-diagnosis instruction B_CMD will be described.

As shown in the diagram, when the self-diagnosis instruction B_CMD is transmitted, in the low level period of the input pulse signal IN (hence in the low level period of the output pulse signal OUT and the switching-state signal OSFB), pulse groups are generated in the off-signal Soff at the pulse period T1. Meanwhile, if pulse groups satisfying a predetermined judgment condition (TL<T2<TH) are detected consecutively over a plurality of periods, the off-signal Soff is correctly judged to be the self-diagnosis instruction B_CMD.

Finally, with reference to the right region of the diagram, the behavior (indicated as “BIST_ERROR” in the diagram) that produces an unintended self-diagnosis instruction B_CMD will be described. When the input pulse signal IN falls from high level to low level, the output pulse signal OUT also falls to low level.

Note, however, that during the off transition of the switching device TR1 occurs a period in which the output pulse signal OUT falls relatively slowly (what is called a plateau region). Thus, if noise or the like is induced in the output pulse signal OUT, the switching-state signal OSFB may accidentally fall into a state where it oscillates between high and low levels at the pulse period T1.

In terms of what is shown in the diagram, when the output pulse signal OUT is higher than a higher-threshold-value voltage VosfbH, the switching-state signal OSFB is at high level. On the other hand, when the output pulse signal OUT is lower than a lower-threshold-value voltage VosfbL (<VosfbH), the switching-state signal OSFB is at low level.

Once in this state, a period appears in which, despite the input pulse signal IN being at low level, the switching-state signal OSFB is at high level. In this period, the off-signal Soff is pulse-driven in order to make the logic level of the switching-state signal OSFB consistent with that of the input pulse signal IN. As a result, the off-signal Soff may be erroneously judged to be a self-diagnosis instruction B_CMD.

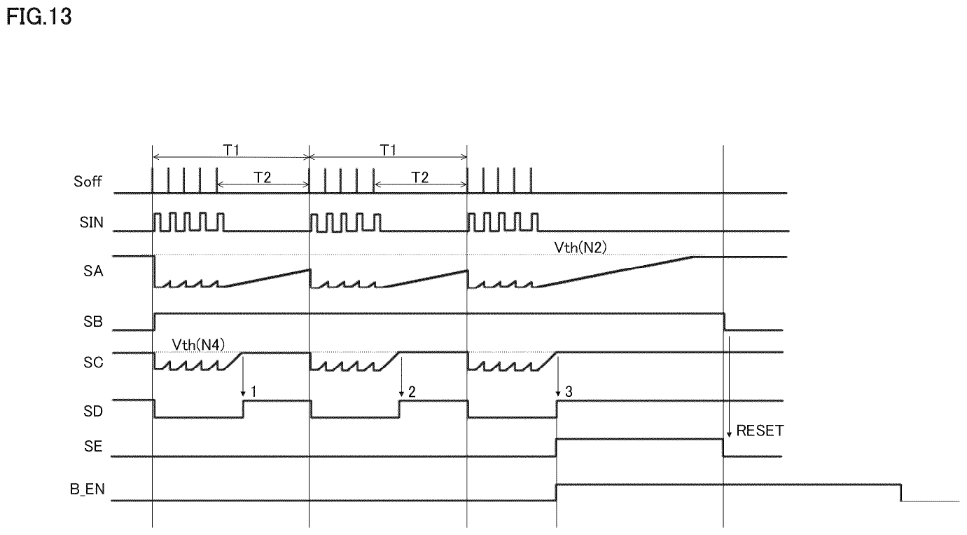

FIG. 13 is a diagram showing how the self-diagnosis circuit 520 recognizes an unintended self-diagnosis instruction. The diagram depicts, from top down, the off-signal Soff, the internal signal SIN, the internal signals SA to SE, and the self-diagnosis enable signal B_EN.

In the state shown in the right region in FIG. 12 described previously, if the signal interval T2 between pulse groups generated in the off-signal Soff at the pulse period T1 falls within a predetermined region (TL<T2<TH), with the internal signal SB kept at high level, consecutive pulses are generated in the internal signal SD. Meanwhile, the counter 525 keeps counting, without being reset, the number of pulses in the internal signal SD. Then, when the count value of the counter 525 reaches a predetermined threshold value (three in the diagram), the internal signal SE rises to high level. As a result, the self-diagnosis enable signal B_EN rises to high level and self-diagnosis operation starts unintentionally.

Note that after pulses stop being generated in the off-signal Soff, when the signal interval T2 in the off-signal Soff reaches the upper limit time TH, the internal signal SB falls to low level. This resets the counter 525 and turns the internal signal SE to low level. The self-diagnosis enable signal B_EN is, however, kept at high level until an internal signal SF, not shown, falls to low level.

In view of the study above, in the following description, a second embodiment is presented that helps prevent the starting of unintended self-diagnosis operation.

### Signal Transmission Device (Second Embodiment)

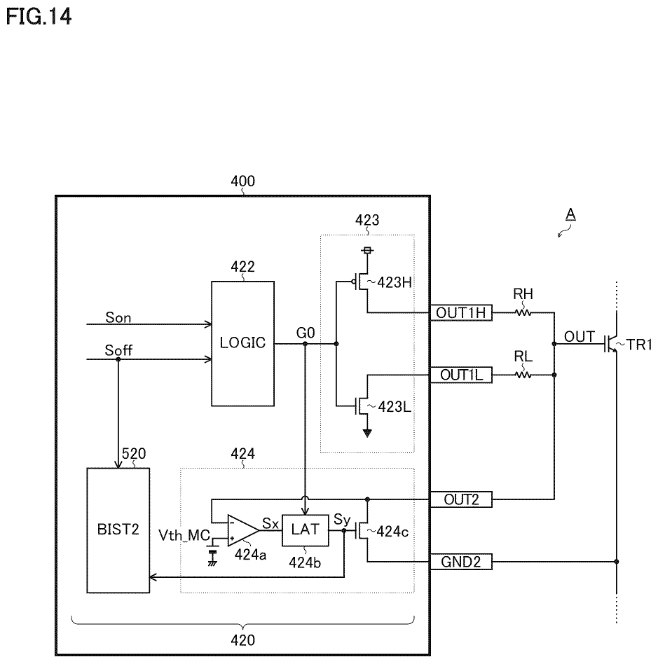

FIG. 14 is a diagram showing a signal transmission device of a second embodiment. The signal transmission device 400 of this embodiment is based on the first embodiment (FIG. 10 and FIG. 11) described previously and further devised to prevent the starting of unintended self-diagnosis operation.

For example, the self-diagnosis circuit 520 takes the self-diagnosis instruction B_CMD transmitted from the controller chip 410 as valid only when the output pulse signal OUT is stably at low level. Conversely, the self-diagnosis circuit 520 ignores the self-diagnosis instruction B_CMD as invalid unless the output pulse signal OUT is stably at low level. Such a configuration helps avoid, even in the situation shown in the right region in FIG. 12, the starting of unintended self-diagnosis operation.

In terms of what is shown in the diagram, the driver chip 420 includes, in addition to the logic circuit 422, the driver 423, and the self-diagnosis circuit 520 described previously, a mirror clamp 424. Only when the mirror clamp 424 is operating does the self-diagnosis circuit 520 take the self-diagnosis instruction B_CMD as valid. This will now be described in detail with reference to the drawings.

The driver 423 includes a transistor 423H (e.g., PMOSFET) and a transistor 423L (e.g., NMOSFET).

The source of the transistor 423H is connected to a first potential terminal (e.g., a positive power source terminal). The drain of the transistor 423H is connected via an OUT1H pin and a gate resistor RH to the gate of the switching device TR1 (an application terminal for the output pulse signal OUT). The gate of the transistor 423H is connected to an application terminal for the driver driving signal G0.

The source of the transistor 423L is connected to a second potential terminal (e.g., a negative power source terminal). The drain of the transistor 423L is connected via an OUT1L pin and a gate resistor RL to the gate of the switching device TR1. The gate of the transistor 423L is connected to the application terminal for the driver driving signal G0.

For example, when the driver driving signal G0 is at low level, the transistor 423H is on and the transistor 423L is off. Thus, the output pulse signal OUT rises at a slew rate corresponding to the gate resistor RH. As a result, the switching device TR1 turns on.

On the other hand, when the driver driving signal G0 is at high level, the transistor 423H is off and the transistor 423L is on. Thus, the output pulse signal OUT falls at a slew rate corresponding to the gate resistor RL. As a result, the switching device TR1 turns off.

The mirror clamp 424 fixes the output pulse signal OUT at low level (the logic level corresponding to an off state). In terms of what is shown in the diagram, the mirror clamp 424 includes a comparator 424a, a latch 424b, and a transistor 424c (e.g., NMOSFET).

The comparator 424a compares a terminal voltage at an OUT2 pin, which is input to its inverting input terminal (−) (corresponding to the output pulse signal OUT), with a threshold-value voltage Vth_MC, which is input to its non-inverting input terminal (+), to generate an internal signal Sx. The internal signal Sx is at low level when the output pulse signal OUT is higher than the threshold-value voltage Vth_MC. On the other hand, the internal signal Sx is at high level when the output pulse signal OUT is lower than the threshold-value voltage Vth_MC. Note that the threshold-value voltage Vth_MC is preferably set at a voltage that is sufficiently lower than the lower-threshold-value voltage VosfbL mentioned previously (see FIG. 12 referred to previously).

The latch 424b receives the internal signal Sx and the driver driving signal G0, and outputs an internal signal Sy. For example, the latch 424b outputs the internal signal Sx unchanged as the internal signal Sy when the driver driving signal G0 is at high level (the logic level corresponding to an off state of the switching device TR1). On the other hand, the latch 424b fixes the internal signal Sy at low level regardless of the internal signal Sx when the driver driving signal G0 is at low level (the logic level corresponding to an on state of the switching device TR1).

The drain of the transistor 424c is connected to the OUT2 pin (hence to the gate of the switching device TR1). The source of the transistor 424c is connected to a GND2 pin (hence to the emitter of the switching device TR1). The gate of the transistor 424c is connected to an application terminal for the internal signal Sy. Thus, the transistor 424c is on when the internal signal Sy is at high level and is off when the internal signal Sy is at low level.

The mirror clamp 424 can short-circuit between the gate and the emitter of the switching device TR1 via the transistor 424c, which is of a low-impedance type. This reliably turns off the switching device TR1.

Note that, as described above, the self-diagnosis circuit 520 can take the self-diagnosis instruction B_CMD as valid only when the mirror clamp 424 is operating. In terms of what is shown in the diagram, the self-diagnosis circuit 520 can take the self-diagnosis instruction B_CMD as valid, for example, only when the internal signal Sy is at high level.

Such a configuration helps prevent the starting of unintended self-diagnosis operation even in a situation as shown in the right region in FIG. 12 where noise is induced in the output pulse signal OUT during the off transition of the switching device TR1.

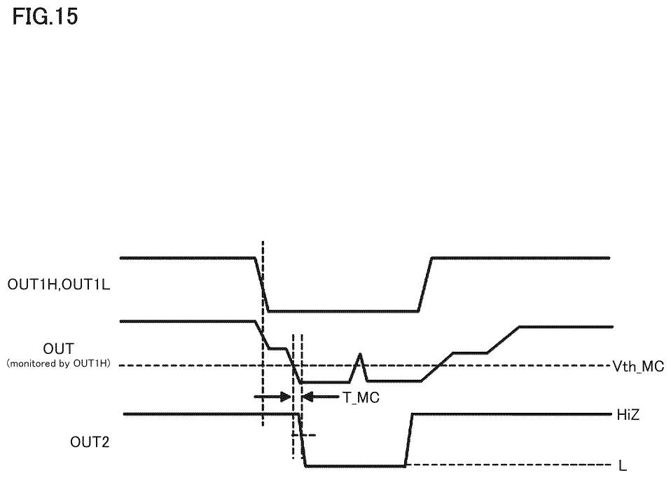

FIG. 15 is a diagram showing one example of mirror clamp operation. The diagram depicts, from top down, the terminal states of the OUT1H and OUT1L pins, the output pulse signal OUT, and the terminal state of the OUT2 pin.

As shown in the diagram, when the OUT1H and OUT1L pins fall from high level to low level, also the output pulse signal OUT falls from high level to low level. Meanwhile, the output pulse signal OUT has a period in which it falls relatively slowly (what is called a plateau region).

After the plateau region, the output pulse signal OUT starts to fall again. When the output pulse signal OUT becomes lower than the threshold-value voltage Vth_MC, the mirror clamp 424 operates. This turns on the transistor 424c and switches the OUT2 pin from a high-impedance state to low level. Note that after the output pulse signal OUT falls below the threshold-value voltage Vth_MC until the OUT2 pin falls to low level, a predetermined delay time T_MC can be provided.

As will be understood from the sequence of behavior described above, with the configuration where the self-diagnosis instruction B_CMD is taken as valid only when the mirror clamp 424 is operating, even if an unintended self-diagnosis instruction B_CMD (see the right region in FIG. 12) appears resulting from noise induced in the plateau region, it is possible to prevent the starting of erroneous self-diagnosis operation.

### Application to Vehicle

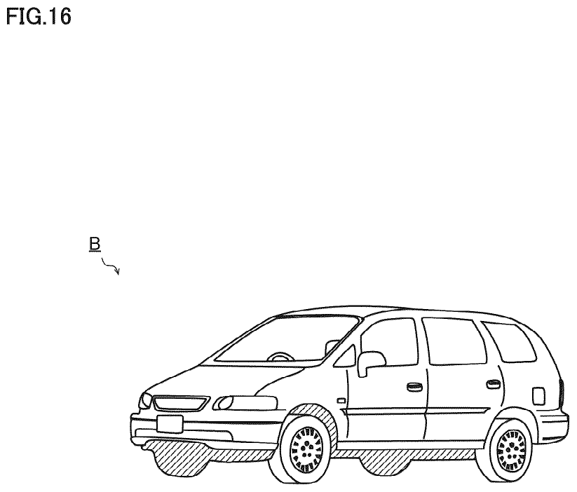

FIG. 16 is a diagram showing the exterior appearance of a vehicle. The vehicle B of this configuration example incorporates various electronic devices that operate with power supplied from a battery.

The vehicle B can be an engine vehicle, or an electric vehicle (an xEV such as a BEV [battery electric vehicle], HEV [hybrid electric vehicle], PHEV/PHV [plug-in hybrid electric vehicle/plug-in hybrid vehicle], or FCEV/FCV [fuel cell electric vehicle/fuel cell vehicle]).

Here, the signal transmission device 200 or 400 described previously can be built in any of the electronic devices incorporated in the vehicle B.

### Overview

According to the present invention, it is possible to provide a signal transmission device, an electronic device, and a vehicle capable of helping prevent the stargin of unintended self-diagnosis operation. To follow is an overview of the various embodiments described above.

For example, according to one aspect of the present disclosure, a signal transmission device includes a first chip configured to be fed with an input pulse signal and a second chip configured to drive a switching device by generating an output pulse signal according to the input pulse signal through isolated communication with the first chip. The second chip includes a self-diagnosis circuit configured to check whether individual parts of the second chip are operating properly in response to a self-diagnosis instruction transmitted from the first chip only when the output pulse signal is at a logic level corresponding to an off state. (A first configuration.)

In the signal transmission device according to the first configuration described above, the second chip can further include a mirror clamp configured to fix the output pulse signal at the logic level corresponding to the off state and the self-diagnosis circuit can take the self-diagnosis instruction as valid only when the mirror clamp is operating. (A second configuration.)

In the signal transmission device according to the first or the second configuration described above, the first chip can notify the second chip via a first isolating device that the input pulse signal is at a logic level to turn on the switching device and notify the second chip via a second isolating device that the input pulse signal is at a logic level to turn off the switching device. (A third configuration.)

In the signal transmission device according to the third configuration described above, the first chip can transmit the self-diagnosis instruction by driving the second isolating device at a different pulse period than in ordinary operation. (A fourth configuration.)

In the signal transmission device according to the third or the fourth configuration described above, the second chip can generate a switching-state signal according to a logic level of the output pulse signal to provide feedback for the first chip. (A fifth configuration.)

In the signal transmission device according to the fifth configuration described above, the first chip can once again notify the second chip of the logic level of the input pulse signal if the logic levels of the input pulse signal and the switching-state signal are inconsistent with each other. (A sixth configuration.)

The signal transmission device according to any one of the third to sixth configurations described above can include a third chip in which the first and second isolating devices are integrated. (A seventh configuration.)

In the signal transmission device according to the seventh configuration described above, the first, second, and third chips are sealed in a single package. (An eighth configuration.)

For example, according to another aspect of the present disclosure, an electronic device includes the signal transmission device according to any one of the first to eighth configurations described above and the switching device configured to be driven by the output pulse signal. (A ninth configuration.)

For example, according to another aspect of the present disclosure, a vehicle includes the electronic device according to the ninth configuration described above. (A tenth configuration.)

### Notes

The various technical features disclosed in the present description can be implemented in any manner other than as specifically described above and allow for various modifications without departure from the spirit of their technical ingenuity. That is, the embodiments described above should be taken to be in every aspect illustrative and not restrictive. The technical scope of the present disclosure should be understood to be defined by the appended claims and to encompass any variations within a scope equivalent in significance to the scope of those claims.

1. A signal transmission device comprising:
a first chip configured to be fed with an input pulse signal; and
a second chip configured to drive a switching device by generating an output pulse signal according to the input pulse signal through isolated communication with the first chip;
wherein
the second chip includes a self-diagnosis circuit configured to check whether individual parts of the second chip are operating properly in response to a self-diagnosis instruction transmitted from the first chip only when the output pulse signal is at a logic level corresponding to an off state.

2. The signal transmission device according to claim 1, wherein
the second chip further includes a mirror clamp configured to fix the output pulse signal at the logic level corresponding to the off state, and
the self-diagnosis circuit takes the self-diagnosis instruction as valid only when the mirror clamp is operating.

3. The signal transmission device according to claim 1, wherein
the first chip notifies the second chip via a first isolating device that the input pulse signal is at a logic level to turn on the switching device and notifies the second chip via a second isolating device that the input pulse signal is at a logic level to turn off the switching device.

4. The signal transmission device according to claim 3, wherein
the first chip transmits the self-diagnosis instruction by driving the second isolating device at a different pulse period than in ordinary operation.

5. The signal transmission device according to claim 3, wherein
the second chip generates a switching-state signal according to a logic level of the output pulse signal to provide feedback for the first chip.

6. The signal transmission device according to claim 5, wherein
the first chip once again notifies the second chip of the logic level of the input pulse signal if the logic levels of the input pulse signal and the switching-state signal are inconsistent with each other.

7. The signal transmission device according to claim 3 further comprising:
a third chip in which the first and second isolating devices are integrated.

8. The signal transmission device according to claim 7, wherein
the first, second, and third chips are sealed in a single package.

9. An electronic device comprising:
the signal transmission device according to claim 1; and
the switching device configured to be driven by the output pulse signal.

10. A vehicle comprising the electronic device according to claim 9.
